(19) United States
(12) Patent Application Publication
(10) Pub. No.: US 2025/0287216 A1
(43) Pub. Date: Sep. 11, 2025

(54) SIGNAL STRENGTH-BASED SELECTION BETWEEN SPATIAL REUSE OR MULTI-PRIMARY CHANNEL COMMUNICATION MODES

(71) Applicant: QUALCOMM Incorporated, San Diego, CA (US)

(72) Inventors: Abhi SHIVAMURTHY, Bangalore (IN); Devesh SINGH, Bangalore (IN); Gaurang NAIK, San Diego, CA (US)

(21) Appl. No.: 18/597,583

(22) Filed: Mar. 6, 2024

(51) Int. Cl. H04W 16/14; H04B 17/318; H04B 17/336; H04W 8/22

(52) U.S. Cl. CPC H04W 16/14; H04B 17/328; H04B 17/336; H04W 8/22

(57) ABSTRACT

This disclosure provides methods, components, devices and systems for signal strength-based selection between spatial reuse or multi-primary channel communication modes. Some aspects more specifically relate to how an access point (AP) or station (STA) may select between a spatial reuse communication mode or a multi-primary channel communication mode in accordance with a threshold value and one or more signal strength measurements at the AP or STA. In some examples, the AP may transmit an indication of the threshold value to the STA. In some aspects, the AP or STA may select the spatial reuse communication mode in accordance with the signal strength measurement(s) at the AP or STA satisfying the threshold value. In some other aspects, the AP or STA may select the multi-primary channel communication mode in accordance with the signal strength measurement(s) at the AP or STA failing to satisfy the threshold value.

### TECHNICAL FIELD

This disclosure relates generally to wireless communication and, more specifically, to signal strength-based selection between spatial reuse or multi-primary channel communication modes.

### DESCRIPTION OF THE RELATED TECHNOLOGY

Wireless communication networks are widely deployed to provide various types of communication content such as voice, video, packet data, messaging, broadcast, and so on. Some wireless communication networks may be capable of supporting communication with multiple users by sharing the available system resources (such as time, frequency, or power). Further, a wireless communication network may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM), among other examples. Wireless communication devices may communicate in accordance with any one or more of such wireless communication technologies, and may include wireless stations (STAs), wireless access points (APs), user equipment (UEs), network entities, or other wireless nodes.

In some wireless local area networks (WLANs), an AP may serve a basic service set (BSS) of STAs associated with the AP. The AP may schedule or control communication within the BSS, which may be understood as in-BSS communication, and, in some scenarios, may schedule communication to avoid experiencing interference from or causing interference to other wireless communication devices of other BSSs. For example, multiple BSSs may be located in a same or similar area and communication within each of the multiple BSSs may cause interference to other BSSs. In some networks, an interfering BSS may be understood as an overlapping BSS (OBSS). For example, a wireless communication device of a first BSS may understand a second BSS as an OBSS in examples in which communication with one or more wireless communication devices of the second BSS potentially interferes with communication of one or more wireless communication devices of the first BSS.

An AP may schedule communication to avoid experiencing interference from or causing interference to an OBSS in various ways, including in accordance with spatial reuse or multi-primary channel access. In accordance with spatial reuse, an AP may allow for simultaneous transmission with an OBSS transmission in examples in which the AP determines that the in-BSS transmission is likely to cause less than a threshold amount of interference to the OBSS transmission. Alternatively, the AP may delay the in-BSS transmission until after the OBSS transmission. In accordance with multi-primary channel access, an AP may switch from a main primary (M-Primary) subchannel to an opportunistic primary (O-Primary) subchannel in examples in which the AP measures or detects an OBSS transmission via the M-Primary subchannel. Whether an AP employs spatial reuse or multi-primary channel access may depend on AP (and/or STA) capability and, in at least some ad hoc network deployments including APs and/or STAs of varying capabilities, each AP and/or STA may permanently select one of spatial reuse or multi-primary channel access without coordination. Such a lack of coordination and permanent selection by each AP and/or STA may result in inefficient spectrum usage, as an AP or STA of the APs and/or STAs may default to one of spatial reuse or multi-primary channel access without sufficient consideration to network dynamics and/or conditions.

### SUMMARY

The systems, methods, and devices of this disclosure each have several innovative aspects, no single one of which is solely responsible for the desirable attributes disclosed herein.

One innovative aspect of the subject matter described in this disclosure can be implemented in a wireless access point (AP). The wireless AP may include a processing system that includes processor circuitry and memory circuitry that stores code. The processing system may be configured to cause the wireless AP to transmit an indication of a threshold value associated with a selection between a spatial reuse communication mode or a multi-primary channel communication mode and communicate using the spatial reuse communication mode or the multi-primary channel communication mode in accordance with at least a first signal strength measurement at the wireless AP and with the threshold value.

Another innovative aspect of the subject matter described in this disclosure can be implemented in a method for wireless communication by or at a wireless AP. The method may include transmitting an indication of a threshold value associated with a selection between a spatial reuse communication mode or a multi-primary channel communication mode and communicating using the spatial reuse communication mode or the multi-primary channel communication mode in accordance with at least a first signal strength measurement at the wireless AP and with the threshold value.

Another innovative aspect of the subject matter described in this disclosure can be implemented in a wireless AP. The wireless AP may include means for transmitting an indication of a threshold value associated with a selection between a spatial reuse communication mode or a multi-primary channel communication mode and means for communicating using the spatial reuse communication mode or the multi-primary channel communication mode in accordance with at least a first signal strength measurement at the wireless AP and with the threshold value.

Another innovative aspect of the subject matter described in this disclosure can be implemented in a non-transitory computer-readable medium storing code for wireless communication by or at a wireless AP. The code may include instructions executable by a processing system to transmit an indication of a threshold value associated with a selection between a spatial reuse communication mode or a multi-primary channel communication mode and communicate using the spatial reuse communication mode or the multi-primary channel communication mode in accordance with at least a first signal strength measurement at the wireless AP and with the threshold value.

In some implementations of the method, wireless APs, and non-transitory computer-readable medium described herein, communicating using the spatial reuse communication mode or the multi-primary channel communication mode may include operations, features, means, or instructions for communicating using the spatial reuse communication mode in accordance with a satisfaction of the threshold value, the satisfaction of the threshold value associated with at least the first signal strength measurement and communicating using the multi-primary channel communication mode in accordance with a failure to satisfy the threshold value, the failure to satisfy the threshold value associated with at least the first signal strength measurement.

Some implementations of the method, wireless APs, and non-transitory computer-readable medium described herein may further include operations, features, means, or instructions for transmitting an indication of an updated threshold value associated with the selection between the spatial reuse communication mode or the multi-primary channel communication mode and communicating using the spatial reuse communication mode or the multi-primary channel communication mode in accordance with the updated threshold value.

Some implementations of the method, wireless APs, and non-transitory computer-readable medium described herein may further include operations, features, means, or instructions for transmitting an indication of a set of multiple threshold values associated with the selection between the spatial reuse communication mode or the multi-primary channel communication mode, where each respective threshold value of the set of multiple threshold values may be indicated for at least one wireless communication device of a set of multiple wireless communication devices associated with the wireless AP, and where the set of multiple threshold values includes the threshold value.

Some implementations of the method, wireless APs, and non-transitory computer-readable medium described herein may further include operations, features, means, or instructions for transmitting, using the spatial reuse communication mode or the multi-primary channel communication mode in accordance with at least the first signal strength measurement and with the threshold value, a first frame including a receiver address indicative of a wireless communication device, updating the threshold value by a delta value to a second threshold value in accordance with a failure to satisfy a criteria associated with reception, from the wireless communication device, of a second frame associated with the first frame, and communicating with the wireless communication device using the spatial reuse communication mode or the multi-primary channel communication mode in accordance with the second threshold value.

Some implementations of the method, wireless APs, and non-transitory computer-readable medium described herein may further include operations, features, means, or instructions for maintaining a respective threshold value for each wireless communication device associated with the wireless AP on a per-overlapping basic service set (OBSS) basis.

Another innovative aspect of the subject matter described in this disclosure can be implemented in a wireless station (STA). The wireless STA may include a processing system that includes processor circuitry and memory circuitry that stores code. The processing system may be configured to cause the wireless STA to receive an indication of a threshold value associated with a selection between a spatial reuse communication mode or a multi-primary channel communication mode and communicate using the spatial reuse communication mode or the multi-primary channel communication mode in accordance with at least a first signal strength measurement at the wireless STA and with the threshold value.

Another innovative aspect of the subject matter described in this disclosure can be implemented in a method for wireless communication by or at a wireless STA. The method may include receiving an indication of a threshold value associated with a selection between a spatial reuse communication mode or a multi-primary channel communication mode and communicating using the spatial reuse communication mode or the multi-primary channel communication mode in accordance with at least a first signal strength measurement at the wireless STA and with the threshold value.

Another innovative aspect of the subject matter described in this disclosure can be implemented in a wireless STA. The wireless STA may include means for receiving an indication of a threshold value associated with a selection between a spatial reuse communication mode or a multi-primary channel communication mode and means for communicating using the spatial reuse communication mode or the multi-primary channel communication mode in accordance with at least a first signal strength measurement at the wireless STA and with the threshold value.

Another innovative aspect of the subject matter described in this disclosure can be implemented in a non-transitory computer-readable medium storing code for wireless communication by or at a wireless STA. The code may include instructions executable by one or more processors to receive an indication of a threshold value associated with a selection between a spatial reuse communication mode or a multi-primary channel communication mode and communicate using the spatial reuse communication mode or the multi-primary channel communication mode in accordance with at least a first signal strength measurement at the wireless STA and with the threshold value.

In some implementations of the method, wireless STAs, and non-transitory computer-readable medium described herein, communicating using the spatial reuse communication mode or the multi-primary channel communication mode may include operations, features, means, or instructions for communicating using the spatial reuse communication mode in accordance with a satisfaction of the threshold value, the satisfaction of the threshold value associated with at least the first signal strength measurement and communicating using the multi-primary channel communication mode in accordance with a failure to satisfy the threshold value, the failure to satisfy the threshold value associated with at least the first signal strength measurement.

Some implementations of the method, wireless STAs, and non-transitory computer-readable medium described herein may further include operations, features, means, or instructions for receiving an indication of an updated threshold value associated with the selection between the spatial reuse communication mode or the multi-primary channel communication mode and communicating using the spatial reuse communication mode or the multi-primary channel communication mode in accordance with the updated threshold value.

Some implementations of the method, wireless STAs, and non-transitory computer-readable medium described herein may further include operations, features, means, or instructions for transmitting, using the spatial reuse communication mode or the multi-primary channel communication mode in accordance with at least the first signal strength measurement and with the threshold value, a first frame including a receiver address indicative of a wireless communication device, updating the threshold value by a delta value to a second threshold value in accordance with a failure to satisfy a criteria associated with reception, from the wireless communication device, of a second frame associated with the first frame, and communicating with the wireless communication device using the spatial reuse communication mode or the multi-primary channel communication mode in accordance with the second threshold value.

Some implementations of the method, wireless STAs, and non-transitory computer-readable medium described herein may further include operations, features, means, or instructions for maintaining a respective threshold value for each wireless communication device associated with the wireless STA on a per-OBSS basis.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2 shows a pictorial diagram of another example wireless communication network.

FIGS. 3A and 3B show example signaling diagrams that support signal strength-based selection between spatial reuse or multi-primary channel communication modes.

FIG. 4 shows another example signaling diagram that supports signal strength-based selection between spatial reuse or multi-primary channel communication modes.

FIGS. 5 and 6 show example communication timelines associated with a signal strength-based selection of a multi-primary channel communication mode.

FIG. 7 shows an example communication timeline associated with a strength-based selection of spatial reuse channel communication mode.

FIG. 8 shows an example process flow that supports signal strength-based selection between spatial reuse or multi-primary channel communication modes.

FIG. 9 shows a block diagram of an example wireless communication device that supports signal strength-based selection between spatial reuse or multi-primary channel communication modes.

FIG. 10 shows a block diagram of an example wireless communication device that supports signal strength-based selection between spatial reuse or multi-primary channel communication modes.

FIGS. 11-13 show flowcharts illustrating example processes performable by or at a wireless access point (AP) that supports signal strength-based selection between spatial reuse or multi-primary channel communication modes.

FIGS. 14-16 show flowcharts illustrating example processes performable by or at a wireless station (STA) that supports signal strength-based selection between spatial reuse or multi-primary channel communication modes.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G, 5G (New Radio (NR)) or 6G standards promulgated by the 3rd Generation Partnership Project (3GPP), among others. The described examples can be implemented in any suitable device, component, system or network that is capable of transmitting and receiving RF signals according to one or more of the following technologies or techniques: code division multiple access (CDMA), time division multiple access (TDMA), orthogonal frequency division multiplexing (OFDM), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO (MU-MIMO). The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), a non-terrestrial network (NTN), or an internet of things (IOT) network.

Various aspects relate generally to one or more configuration- or signaling-based mechanisms according to which a wireless communication device may select between a spatial reuse communication mode or a multi-primary channel communication mode. Some aspects more specifically relate to how the wireless communication device may select between the spatial reuse communication mode or the multi-primary channel communication mode in accordance with a threshold value and one or more signal strength measurements, for example, at the wireless communication device. Such a threshold value may correspond to a signal-to-interference plus noise ratio (SINR) or an interference level, among other examples. In some examples, an access point (AP) may transmit, to one or more associated stations (STAs), an indication of the threshold value. The indication by the AP may indicate a same threshold value to a set of STAs associated with the AP and/or may indicate different threshold values to different STAs. In some aspects, the wireless communication device (such as the AP or a STA) may select to use the spatial reuse communication mode in accordance with the one or more signal strength measurements at the wireless communication device satisfying the threshold value. In some other aspects, the wireless communication device may select the multi-primary channel communication mode in accordance with the one or more signal strength measurements at the wireless communication device failing to satisfy the threshold value. Such one or more signal strength measurements may include an overlapping basic service set (BSS) (OBSS) received signal strength indicator (RSSI) and/or an in-BSS RSSI (such as a link RSSI). Further, a spatial reuse communication mode may refer to at least an attempt for spatial reuse with an OBSS transmission. A multi-primary channel communication mode may refer to a switching from a first primary subchannel to a second primary subchannel upon detection of an OBSS transmission. Various further example implementations relate to an outer loop correction mechanism according to which the wireless communication device may maintain a respective threshold value for each wireless communication device with which the wireless communication device may communicate on a per OBSS basis, among other aspects.

Particular aspects of the subject matter described in this disclosure can be implemented to realize one or more of the following potential advantages. In some examples, by leveraging the threshold value that supports a selection between the spatial reuse communication mode and the multi-primary channel communication mode, the described techniques can be used to dynamically switch between the spatial reuse communication mode and the multi-primary channel communication mode in accordance with changing network conditions, which may provide greater utilization of available link capacity while also supporting BSS- and device-level flexibility. Further, by leveraging the threshold value, networks may be able to more fully and accurately realize the efficiency and/or data rate gains provided by both the spatial reuse communication mode and multi-primary communication mode by prioritizing (and selecting) which of the spatial reuse communication mode or the multi-primary communication mode provides a relatively higher efficiency and/or data rate gain in accordance with current network conditions. Thus, the described techniques may be able to more fully realize the capabilities and performance of various generations of wireless communication devices across various types of network deployments, including ad hoc network deployments. Additionally, by supporting various signaling mechanisms according to which an AP may announce one or more threshold values, the described techniques may provide greater flexibility and network control over a frequency of a selection of spatial reuse relative to multi-primary channel access, or vice versa, on a BSS- or client-level basis, which may support more granular client prioritization or customization and/or a balance of any BSS- or client-level trade-offs between spatial reuse and multi-primary channel access. Moreover, by supporting an outer loop correction mechanism according to which a transmitter device may maintain a respective threshold value for each receiver device on a per OBSS basis, the described techniques may be implemented to realize greater synchronization and fewer communication errors over time via a self-correcting mechanism with relatively minimal (if any) added signaling overhead. In accordance with such a dynamic adaptation to changing network conditions, BSS- and device-level flexibility and/or customization, more fully realized capability and performance, and fewer communication errors, the described techniques may further support higher data rates, greater spectral efficiency, improved user experience, and greater system capacity, among other benefits.

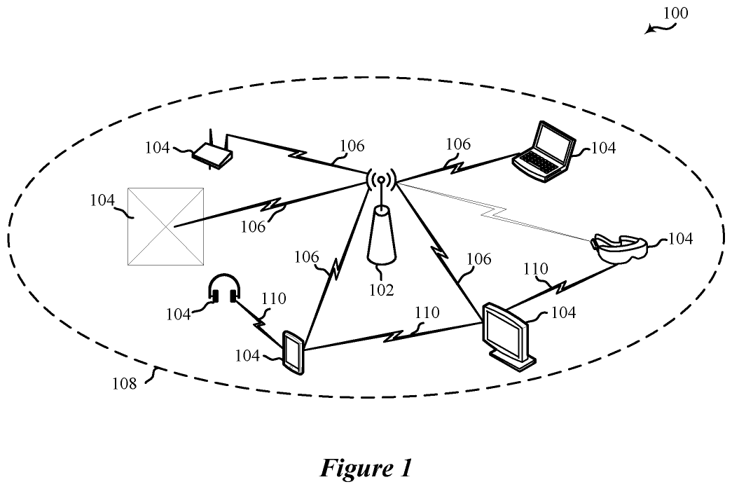

FIG. 1 shows a pictorial diagram of an example wireless communication network 100. According to some aspects, the wireless communication network 100 can be an example of a wireless local area network (WLAN) such as a Wi-Fi network. For example, the wireless communication network 100 can be a network implementing at least one of the IEEE 802.11 family of wireless communication protocol standards (such as defined by the IEEE 802.11-2020 specification or amendments thereof including, but not limited to, 802.11ay, 802.11ax, 802.11az, 802.11ba, 802.11bc, 802.11bd, 802.11be, 802.11bf, and 802.11bn). In some other examples, the wireless communication network 100 can be an example of a cellular radio access network (RAN), such as a 5G or 6G RAN that implements one or more cellular protocols such as those specified in one or more 3GPP standards. In some other examples, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network's core, such as to access the network management capabilities and functionality offered by the cellular network core. In some other examples, the wireless communication network 100 can include a WLAN that functions in an interoperable or converged manner with one or more personal area networks, such as a network implementing Bluetooth or other wireless technologies, to provide greater or enhanced network coverage or to provide or enable other capabilities, functionality, applications or services.

The wireless communication network 100 may include numerous wireless communication devices including at least one wireless access point (AP) 102 and any number of wireless stations (STAs) 104. While only one AP 102 is shown in FIG. 1, the wireless communication network 100 can include multiple APs 102. The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (eNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (such as TVs, computer monitors or video gaming consoles), video game controllers, navigation systems, music or other audio or stereo devices, remote control devices, printers, kitchen appliances (including smart refrigerators) or other household appliances, key fobs (such as for passive keyless entry and start (PKES) systems), Internet of Things (IoT) devices, and vehicles, among other examples.

A single AP 102 and an associated set of STAs 104 may be referred to as a BSS, which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (such as the 2.4 GHz, 5 GHZ, 6 GHz, 45 GHz, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an extended service set (ESS) including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater RSSI or a reduced traffic load.

In some examples, STAs 104 may form networks without APs 102 or other equipment other than the STAs 104 themselves. One example of such a network is an ad hoc network (or wireless ad hoc network). Ad hoc networks may alternatively be referred to as mesh networks or peer-to-peer (P2P) networks. In some examples, ad hoc networks may be implemented within a larger network such as the wireless communication network 100. In such examples, while the STAs 104 may be capable of communicating with each other through the AP 102 using communication links 106, STAs 104 also can communicate directly with each other via direct wireless communication links 110. Additionally, two STAs 104 may communicate via a direct wireless communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency requirements, or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communication (hereinafter also referred to as “Wi-Fi communication” or “wireless packets”) to and from one another in the form of PHY protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the wireless communication network 100 may transmit PPDUs over an unlicensed spectrum, which may be a portion of spectrum that includes frequency bands traditionally used by Wi-Fi technology, such as the 2.4 GHZ, 5 GHz, 6 GHZ, 45 GHz, and 60 GHz bands. Some examples of the APs 102 and STAs 104 described herein also may communicate in other frequency bands that may support licensed or unlicensed communication. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHz-7.125 GHZ), FR2 (24.25 GHZ-52.6 GHZ), FR3 (7.125 GHz-24.25 GHz), FR4a or FR4-1 (52.6 GHz-71 GHz), FR4 (52.6 GHz-114.25 GHz), and FR5 (114.25 GHZ-300 GHz).

Each of the frequency bands may include multiple sub-bands and frequency channels (also referred to as subchannels). The terms “channel” and “subchannel” may be used interchangeably herein, as each may refer to a portion of frequency spectrum within a frequency band (such as a 20 MHz, 40 MHZ, 80 MHz, or 160 MHz portion of frequency spectrum) via which communication between two or more wireless communication devices can occur. For example, PPDUs conforming to the IEEE 802.11n, 802.11ac, 802.11ax, 802.11be and 802.11bn standard amendments may be transmitted over one or more of the 2.4 GHZ, 5 GHZ, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 MHz, 240 MHZ, 320 MHz, 480 MHz, or 640 MHz by bonding together multiple 20 MHz channels.

An AP 102 may determine or select an operating or operational bandwidth for the STAs 104 in its BSS and select a range of channels within a band to provide that operating bandwidth. For example, the AP 102 may select sixteen 20 MHz channels that collectively span an operating bandwidth of 320 MHz. Within the operating bandwidth, the AP 102 may typically select a single primary 20 MHz channel on which the AP 102 and the STAs 104 in its BSS monitor for contention-based access schemes. In some examples, the AP 102 or the STAs 104 may be capable of monitoring only a single primary 20 MHz channel for packet detection (such as for detecting preambles of PPDUs). Conventionally, any transmission by an AP 102 or a STA 104 within a BSS must involve transmission on the primary 20 MHz channel. As such, in conventional systems, the transmitting device must contend on and win a TXOP on the primary channel to transmit anything at all. However, some APs 102 and STAs 104 supporting ultra-high reliability (UHR) communication or communication according to the IEEE 802.11bn standard amendment can be configured to operate, monitor, contend and communicate using multiple primary 20 MHz channels. Such monitoring of multiple primary 20 MHz channels may be sequential such that responsive to determining, ascertaining or detecting that a first primary 20 MHz channel is not available, a wireless communication device may switch to monitoring and contending using a second primary 20 MHz channel. Additionally, or alternatively, a wireless communication device may be configured to monitor multiple primary 20 MHz channels in parallel. In some examples, a first primary 20 MHz channel may be referred to as a main primary (M-Primary) channel and one or more additional, second primary channels may each be referred to as an opportunistic primary (O-Primary) channel. For example, in examples in which a wireless communication device measures, identifies, ascertains, detects, or otherwise determines that the M-Primary channel is busy or occupied (such as due to an overlapping BSS (OBSS) transmission), the wireless communication device may switch to monitoring and contending on an O-Primary channel. In some examples, the M-Primary channel may be used for beaconing and serving legacy client devices and an O-Primary channel may be specifically used by non-legacy (such as UHR- or IEEE 802.11bn-compatible) devices for opportunistic access to spectrum that may be otherwise under-utilized.

In some examples, the AP 102 or the STAs 104 of the wireless communication network 100 may implement Extremely High Throughput (EHT) or other features compliant with current and future generations of the IEEE 802.11 family of wireless communication protocol standards (such as the IEEE 802.11be and 802.11bn standard amendments) to provide additional capabilities over other previous systems (such as High Efficiency (HE) systems or other legacy systems). For example, the IEEE 802.11be standard amendment introduced 320 MHz channels, which are twice as wide as those possible with the IEEE 802.11ax standard amendment. Accordingly, the AP 102 or the STAs 104 may use 320 MHz channels enabling double the throughput and network capacity, as well as providing rate versus range gains at high data rates due to linear bandwidth versus log SNR trade-off. EHT and newer wireless communication protocols (such as the protocols referred to as or associated with the IEEE 802.11bn standard amendment) may support flexible operating bandwidth enhancements, such as broadened operating bandwidths relative to legacy operating bandwidths or more granular operation relative to legacy operation. For example, an EHT system may allow communication spanning operating bandwidths of 20 MHz, 40 MHz, 80 MHz, 160 MHz, 240 MHz, and 320 MHz. EHT systems may support multiple bandwidth modes such as a contiguous 240 MHz bandwidth mode, a contiguous 320 MHz bandwidth mode, a noncontiguous 160+160 MHz bandwidth mode, or a noncontiguous 80+80+80+80 (or “4×80”) MHz bandwidth mode.

In some examples in which a wireless communication device (such as the AP 102 or the STA 104) operates in a contiguous 320 MHz bandwidth mode or a 160+160 MHz bandwidth mode, signals for transmission may be generated by two different transmit chains of the wireless communication device each having or associated with a bandwidth of 160 MHz (and each coupled to a different power amplifier). In some other examples, two transmit chains can be used to support a 240 MHz/160+80 MHz bandwidth mode by puncturing 320 MHz/160+160 MHz bandwidth modes with one or more 80 MHz subchannels. For example, signals for transmission may be generated by two different transmit chains of the wireless communication device each having a bandwidth of 160 MHz with one of the transmit chains outputting a signal having an 80 MHz subchannel punctured therein. In some other examples in which the wireless communication device may operate in a contiguous 240 MHz bandwidth mode, or a noncontiguous 160+80 MHz bandwidth mode, the signals for transmission may be generated by three different transmit chains of the wireless communication device, each having a bandwidth of 80 MHz. In some other examples, signals for transmission may be generated by four or more different transmit chains of the wireless communication device, each having a bandwidth of 80 MHz.

In noncontiguous examples, the operating bandwidth may span one or more disparate sub-channel sets. For example, the 320 MHz bandwidth may be contiguous and located in the same 6 GHz band or noncontiguous and located in different bands or regions within a band (such as partly in the 5 GHz band and partly in the 6 GHz band).

In some examples, the AP 102 or the STA 104 may benefit from operability enhancements associated with EHT and newer generations of the IEEE 802.11 family of wireless communication protocol standards. For example, the AP 102 or the STA 104 attempting to gain access to the wireless medium of the wireless communication network 100 may perform techniques (which may include modifications to existing rules, structure, or signaling implemented for legacy systems) such as clear channel assessment (CCA) operation based on EHT enhancements such as increased bandwidth, puncturing, or refinements to carrier sensing and signal reporting mechanisms.

In some wireless communication systems, wireless communication between an AP 102 and an associated STA 104 can be secured. For example, either an AP 102 or a STA 104 may establish a security key for securing wireless communication between itself and the other device and may encrypt the contents of the data and management frames using the security key. In some examples, the control frame and fields within the MAC header of the data or management frames, or both, also may be secured either via encryption or via an integrity check (such as by generating a message integrity check (MIC) for one or more relevant fields.

Access to the shared wireless medium is generally governed by a distributed coordination function (DCF). With a DCF, there is generally no centralized master device allocating time and frequency resources of the shared wireless medium. On the contrary, before a wireless communication device, such as an AP 102 or a STA 104, is permitted to transmit data, it may wait for a particular time and contend for access to the wireless medium. The DCF is implemented through the use of time intervals (including the slot time (or “slot interval”) and the inter-frame space (IFS). IFS provides priority access for control frames used for proper network operation. Transmissions may begin at slot boundaries. Different varieties of IFS exist including the short IFS (SIFS), the distributed IFS (DIFS), the extended IFS (EIFS), and the arbitration IFS (AIFS). The values for the slot time and IFS may be provided by a suitable standard specification, such as one or more of the IEEE 802.11 family of wireless communication protocol standards.

In some examples, the wireless communication device (such as the AP 102 or the STA 104) may implement the DCF through the use of carrier sense multiple access (CSMA) with collision avoidance (CA) (CSMA/CA) techniques. According to such techniques, before transmitting data, the wireless communication device may perform a clear channel assessment (CCA) and may determine (such as identify, detect, ascertain, calculate, or compute) that the relevant wireless channel is idle. The CCA includes both physical (PHY-level) carrier sensing and virtual (MAC-level) carrier sensing. Physical carrier sensing is accomplished via a measurement of the received signal strength of a valid frame, which is compared to a threshold to determine (such as identify, detect, ascertain, calculate, or compute) whether the channel is busy. For example, in examples in which the received signal strength of a detected preamble is above a threshold, the medium is considered busy. Physical carrier sensing also includes energy detection. Energy detection involves measuring the total energy the wireless communication device receives regardless of whether the received signal represents a valid frame. In examples in which the total energy detected is above a threshold, the medium is considered busy.

Virtual carrier sensing is accomplished via the use of a network allocation vector (NAV), which effectively serves as a time duration that elapses before the wireless communication device may contend for access even in the absence of a detected symbol or even in examples in which the detected energy is below the relevant threshold. The NAV is reset each time a valid frame is received that is not addressed to the wireless communication device. In examples in which the NAV reaches 0, the wireless communication device performs the physical carrier sensing. In examples in which the channel remains idle for the appropriate IFS, the wireless communication device initiates a backoff timer, which represents a duration of time that the device senses the medium to be idle before it is permitted to transmit. In examples in which the channel remains idle until the backoff timer expires, the wireless communication device becomes the holder (or “owner”) of a transmit opportunity (TXOP) and may begin transmitting. The TXOP is the duration of time the wireless communication device can transmit frames over the channel after it has “won” contention for the wireless medium. The TXOP duration may be indicated in the U-SIG field of a PPDU. If, on the other hand, one or more of the carrier sense mechanisms indicate that the channel is busy, a MAC controller within the wireless communication device will not permit transmission.

Each time the wireless communication device generates a new PPDU for transmission in a new TXOP, it randomly selects a new backoff timer duration. The available distribution of the numbers that may be randomly selected for the backoff timer is referred to as the contention window (CW). There are different CW and TXOP durations for each of the four access categories (ACs): voice (AC_VO), video (AC_VI), background (AC_BK), and best effort (AC_BE). This enables particular types of traffic to be prioritized in the network.

In some other examples, the wireless communication device (such as the AP 102 or the STA 104) may contend for access to the wireless medium of a WLAN in accordance with an enhanced distributed channel access (EDCA) procedure. A random channel access mechanism such as EDCA may afford high-priority traffic a greater likelihood of gaining medium access than low-priority traffic. The wireless communication device using EDCA may classify data into different access categories. Each AC may be associated with a different priority level and may be assigned a different range of random backoffs (RBOs) so that higher priority data is more likely to win a TXOP than lower priority data (such as by assigning lower RBOs to higher priority data and assigning higher RBOs to lower priority data). Although EDCA increases the likelihood that low-latency data traffic will gain access to a shared wireless medium during a given contention period, unpredictable outcomes of medium access contention operations may prevent low-latency applications from achieving certain levels of throughput or satisfying certain latency requirements.

Some APs and STAs (such as the AP 102 and the STAs 104 described with reference to FIG. 1) may implement spatial reuse techniques. For example, APs 102 and STAs 104 configured for communication using the protocols defined in the IEEE 802.11ax or 802.11be standard amendments may be configured with a BSS color. APs 102 associated with different BSSs may be associated with different BSS colors. A BSS color is a numerical identifier of an AP 102's respective BSS (such as a 6 bit field carried by the SIG field). Each STA 104 may learn its own BSS color upon association with the respective AP 102. BSS color information is communicated at both the PHY and MAC sublayers. In examples in which an AP 102 or a STA 104 detects, obtains, selects, or identifies, a wireless packet from another wireless communication device while contending for access, the AP 102 or the STA 104 may apply different contention parameters in accordance with whether the wireless packet is transmitted by, or transmitted to, another wireless communication device (such another AP 102 or STA 104) within its BSS or from a wireless communication device from an overlapping BSS (OBSS), as determined, identified, ascertained, or calculated by a BSS color indication in a preamble of the wireless packet. For example, in examples in which the BSS color associated with the wireless packet is the same as the BSS color of the AP 102 or STA 104, the AP 102 or STA 104 may use a first RSSI detection threshold in examples in which performing a CCA on the wireless channel. However, in examples in which the BSS color associated with the wireless packet is different than the BSS color of the AP 102 or STA 104, the AP 102 or STA 104 may use a second RSSI detection threshold in lieu of using the first RSSI detection threshold when performing the CCA on the wireless channel, the second RSSI detection threshold being greater than the first RSSI detection threshold. In this way, the criteria for winning contention are relaxed in examples in which interfering transmissions are associated with an OBSS.

Some APs and STAs (such as the AP 102 and the STAs 104 described with reference to FIG. 1) may implement techniques for spatial reuse that involve participation in a coordinated communication scheme. According to such techniques, an AP 102 may contend for access to a wireless medium to obtain control of the medium for a TXOP. The AP that wins the contention (hereinafter also referred to as a “sharing AP”) may select one or more other APs (hereinafter also referred to as “shared APs”) to share resources of the TXOP. The sharing and shared APs may be located in proximity to one another such that at least some of their wireless coverage areas at least partially overlap. Some examples may specifically involve coordinated AP TDMA or OFDMA techniques for sharing the time or frequency resources of a TXOP. To share its time or frequency resources, the sharing AP may partition the TXOP into multiple time segments or frequency segments each including respective time or frequency resources representing a portion of the TXOP. The sharing AP may allocate the time or frequency segments to itself or to one or more of the shared APs. For example, each shared AP may utilize a partial TXOP assigned by the sharing AP for its uplink or downlink communication with its associated STAs.

In some examples of such TDMA techniques, each portion of a plurality of portions of the TXOP includes a set of time resources that do not overlap with any time resources of any other portion of the plurality of portions of the TXOP. In such examples, the scheduling information may include an indication of time resources, of multiple time resources of the TXOP, associated with each portion of the TXOP. For example, the scheduling information may include an indication of a time segment of the TXOP such as an indication of one or more slots or sets of symbol periods associated with each portion of the TXOP such as for multi-user TDMA.

In some examples of OFDMA techniques, each portion of the plurality of portions of the TXOP includes a set of frequency resources that do not overlap with any frequency resources of any other portion of the plurality of portions. In such examples, the scheduling information may include an indication of frequency resources, of multiple frequency resources of the TXOP, associated with each portion of the TXOP. For example, the scheduling information may include an indication of a bandwidth portion of the wireless channel such as an indication of one or more subchannels or resource units associated with each portion of the TXOP such as for multi-user OFDMA.

In this manner, the sharing AP's acquisition of the TXOP enables communication between one or more additional shared APs and their respective BSSs, subject to appropriate power control and link adaptation. For example, the sharing AP may limit the transmit powers of the selected shared APs such that interference from the selected APs does not prevent STAs associated with the TXOP owner from successfully decoding packets transmitted by the sharing AP. Such techniques may be used to reduce latency because the other APs may not need to wait to win contention for a TXOP to be able to transmit and receive data according to conventional CSMA/CA or enhanced distributed channel access (EDCA) techniques. Additionally, by enabling a group of APs 102 associated with different BSSs to participate in a coordinated AP transmission session, during which the group of APs may share at least a portion of a single TXOP obtained by any one of the participating APs, such techniques may increase throughput across the BSSs associated with the participating APs and also may achieve improvements in throughput fairness. Furthermore, with appropriate selection of the shared APs and the scheduling of their respective time or frequency resources, medium utilization may be maximized or otherwise increased while packet loss resulting from OBSS interference is minimized or otherwise reduced. Various implementations may achieve these and other advantages without requiring that the sharing AP or the shared APs be aware of the STAs 104 associated with other BSSs, without requiring a preassigned or dedicated master AP or preassigned groups of APs, and without requiring backhaul coordination between the APs participating in the TXOP.

In some examples in which the signal strengths or levels of interference associated with the selected APs are relatively low (such as less than a given value), or in examples in which the decoding error rates of the selected APs are relatively low (such as less than a threshold), the start times of the communication among the different BSSs may be synchronous. Conversely, in examples in which the signal strengths or levels of interference associated with the selected APs are relatively high (such as greater than the given value), or in examples in which the decoding error rates of the selected APs are relatively high (such as greater than the threshold), the start times may be offset from one another by a time period associated with decoding the preamble of a wireless packet and determining, from the decoded preamble, whether the wireless packet is an intra-BSS packet or is an OBSS packet. For example, the time period between the transmission of an intra-BSS packet and the transmission of an OBSS packet may allow a respective AP (or its associated STAs) to decode the preamble of the wireless packet and obtain the BSS color value carried in the wireless packet to determine whether the wireless packet is an intra-BSS packet or an OBSS packet. In this manner, each of the participating APs and their associated STAs may be able to receive and decode intra-BSS packets in the presence of OBSS interference.

In some examples, the sharing AP may perform polling of a set of un-managed or non-co-managed APs that support coordinated reuse to identify candidates for future spatial reuse opportunities. For example, the sharing AP may transmit one or more spatial reuse poll frames as part of determining one or more spatial reuse criteria and selecting one or more other APs to be shared APs. According to the polling, the sharing AP may receive responses from one or more of the polled APs. In some specific examples, the sharing AP may transmit a coordinated AP TXOP indication (CTI) frame to other APs that indicates time and frequency of resources of the TXOP that can be shared. The sharing AP may select one or more candidate APs upon receiving a coordinated AP TXOP request (CTR) frame from a respective candidate AP that indicates a desire by the respective AP to participate in the TXOP. The poll responses or CTR frames may include a power indication, for example, a receive (RX) power or RSSI measured by the respective AP. In some other examples, the sharing AP may directly measure potential interference of a service supported (such as UL transmission) at one or more APs, and select the shared APs based on the measured potential interference. The sharing AP generally selects the APs to participate in coordinated spatial reuse such that it still protects its own transmissions (which may be referred to as primary transmissions) to and from the STAs in its BSS. The selected APs may be allocated resources during the TXOP as described above.

Some APs and STAs, such as, for example, the AP 102 and STAs 104 described with reference to FIG. 1, are capable of multi-link operation (MLO). For example, the AP 102 and STAs 104 may support MLO as defined in one or both of the IEEE 802.11be and 802.11bn standard amendments. An MLO-capable device may be referred to as a multi-link device (MLD). In some examples, MLO supports establishing multiple different communication links (such as a first link on the 2.4 GHz band, a second link on the 5 GHz band, and the third link on the 6 GHz band) between MLDs. Each communication link may support one or more sets of channels or logical entities. For example, an AP MLD may set, for each of the communication links, a respective operating bandwidth, one or more respective primary channels, and various BSS configuration parameters. An MLD may include a single upper MAC entity, and can include, for example, three independent lower MAC entities and three associated independent PHY entities for respective links in the 2.4 GHz, 5 GHZ, and 6 GHz bands. This architecture may enable a single association process and security context. An AP MLD may include multiple APs 102 each configured to communicate on a respective communication link with a respective one of multiple STAs 104 of a non-AP MLD (also referred to as a “STA MLD”).

To support MLO techniques, an AP MLD and a STA MLD may exchange MLO capability information (such as supported aggregation types or supported frequency bands, among other information). In some examples, the exchange of information may occur via a beacon frame, a probe request frame, a probe response frame, an association request frame, an association response frame, another management frame, a dedicated action frame, or an operating mode indicator (OMI), among other examples. In some examples, an AP MLD may designate a specific channel of one link in one of the bands as an anchor channel on which it transmits beacons and other control or management frames periodically. In such examples, the AP MLD also may transmit shorter beacons (such as ones which may contain less information) on other links for discovery or other purposes.

MLDs may exchange packets on one or more of the communication links dynamically and, in some instances, concurrently. MLDs also may independently contend for access on each of the communication links, which achieves latency reduction by enabling the MLD to transmit its packets on the first communication link that becomes available. For example, “alternating multi-link” may refer to an MLO mode in which an MLD may listen on two or more different high-performance links and associated channels concurrently. In an alternating multi-link mode of operation, an MLD may alternate between use of two links to transmit portions of its traffic. Specifically, an MLD with buffered traffic may use the first link on which it wins contention and obtains a TXOP to transmit the traffic. While such an MLD may in some examples be capable of transmitting or receiving on only one communication link at any given time, having access opportunities via two different links enables the MLD to avoid congestion, reduce latency, and maintain throughput.

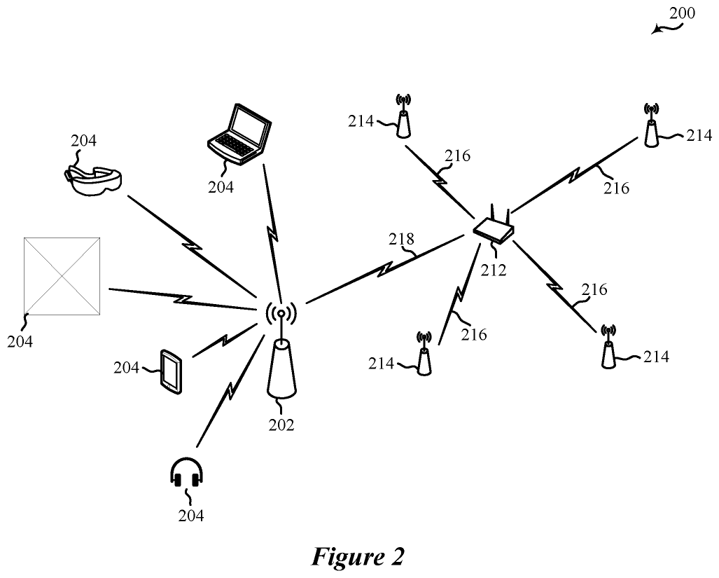

FIG. 2 shows a pictorial diagram of another example wireless communication network 200. According to some aspects, the wireless communication network 200 can be an example of a mesh network, an IoT network, or a sensor network in accordance with one or more of the IEEE 802.11 family of wireless communication protocol standards (including the 802.11ah amendment). The wireless communication network 200 may include multiple wireless communication devices 214, which in some implementations may include APs 202, STAs 204, or both. The wireless communication devices 214 may represent various devices such as display devices (such as TVs, computer monitors, navigation systems, among others), music or other audio or stereo devices, remote control devices (“remotes”), printers, kitchen or other household appliances, among other examples.

In some examples, the wireless communication devices 214 sense, measure, collect or otherwise obtain and process data and transmit such raw or processed data to an intermediate device 212 for subsequent processing or distribution. Additionally, or alternatively, the intermediate device 212 may transmit control information, digital content (such as audio or video data), configuration information or other instructions to the wireless communication devices 214. The intermediate device 212 and the wireless communication devices 214 can communicate with one another via wireless communication links 216. In some examples, the wireless communication links 216 include Bluetooth links or other PAN or short-range communication links.

In some examples, the intermediate device 212 also may be configured for wireless communication with other networks such as with a WLAN or a wireless (such as cellular) wide area network (WWAN), which may, in turn, provide access to external networks including the Internet. For example, the intermediate device 212 may associate and communicate, over a Wi-Fi link 218, with an AP 102 of a wireless communication network 200, which also may serve various STAs 104. In some examples, the intermediate device 212 is an example of a network gateway, for example, an IoT gateway. In such a manner, the intermediate device 212 may serve as an edge network bridge providing a Wi-Fi core backhaul for the IoT network including the wireless communication devices 214. In some examples, the intermediate device 212 can analyze, preprocess and aggregate data received from the wireless communication devices 214 locally at the edge before transmitting it to other devices or external networks via the Wi-Fi link 218. The intermediate device 212 also can provide additional security for the IoT network and the data it transports.

In some deployment scenarios, neighboring or proximate wireless communication devices (such as one or more APs 102, one or more STAs 104, one or more APs 202, one or more STAs 204, one or more intermediate devices 212, and/or one or more wireless communication devices 214) may have varying capabilities. For example, some Wi-Fi networks may be associated with an ad hoc deployment (such as in a residential scenario) in which different wireless communication devices may be associated with different generations, different signaling capabilities, and/or different processing capabilities. In such ad hoc deployments, wireless communication devices may be unable to achieve coordination and synchronization between BSSs (such as neighboring or proximate BSSs). In accordance with such a lack of coordination, wireless communication devices may be unable to employ AP coordination mechanisms, including coordinated medium access mechanisms such as coordinated spatial reuse (C-SR).

In some networks, C-SR may be designed to classify client devices (such as STAs) as inner clients or outer clients. Client devices relatively closer to an AP may experience relatively higher operating signal-to-noise ratios (SNRs) and the AP may classify such client devices as inner clients. The AP may perform spatial reuse transmissions to such inner clients. For client devices relatively far from the AP, the AP may classify such client devices as outer clients and refrain from performing spatial reuse transmissions to such outer clients. In some scenarios, however, a potentially interfering OBSS may be even farther from the AP than the outer clients. In such scenarios, an AP using C-SR may not classify the outer clients as inner clients, and thus not attempt spatial reuse transmissions to such outer clients (even though spatial reuse may be possible due to the relatively greater distance to the potentially interfering OBSS).

Further, in deployments associated with a lack of coordination, wireless communication devices may fallback to one or more default or legacy mechanisms, such as spatial reuse (such as uncoordinated spatial reuse, such as an 802.11ax spatial reuse mechanism). Such deployments also may be associated with wireless communication devices having different bandwidth capabilities, which may provide opportunities for multi-primary channel access. For example, a first subset of wireless communication devices may support wide bandwidth operation (such as 320 MHz bandwidth operation), and may further support an M-Primary subchannel and an O-Primary subchannel for multi-primary channel access, and a second subset of wireless communication devices may not support wide bandwidth operation or multi-primary channel access. Multi-primary channel access may be equivalently referred to as non-primary channel access (NPCA) and may generally relate to how a wireless communication device may (at least sequentially in time if not in parallel) use different subchannels (such as different 20 MHz subchannels) as a primary subchannel.

If a wireless communication device supports primary channel access (such as NPCA), the wireless communication device may switch from an M-Primary subchannel to an O-Primary subchannel in accordance with detecting that the M-Primary subchannel is busy (such as due to an OBSS transmission). In this way, the wireless communication device may more efficiently use the available spectrum. For example, in examples in which the OBSS is bandwidth limited relative to the wireless communication device, the wireless communication device may transmit via at least a portion of a remainder of a total available bandwidth (and thus make use of bandwidth that might have otherwise gone unused). Such an automatic switch to the O-Primary subchannel, however, may result in relatively lower network throughout in some scenarios (such as high operating SINR scenarios), as a transmission using multi-primary channel access may only use a partial bandwidth of the total available bandwidth (such that the transmission has a relatively smaller bandwidth than the transmission might have otherwise had, including that the transmission might have had in examples in which spatial reuse was instead performed).

In deployments associated with wireless communication devices of varying capabilities (such as ad hoc deployments), wireless communication devices may autonomously select between a multi-primary channel communication mode (such as an NPCA communication mode) or a spatial reuse communication mode (such as an 802.11ax spatial reuse communication mode). Multi-primary channel access and spatial reuse may be understood as orthogonal medium access mechanisms or schemes and may lack compatibility (such that employing both simultaneously may be unfeasible). For example, in accordance with a multi-primary channel communication mode, in examples in which an OBSS transmission is heard (such as detected) via an M-Primary subchannel, a wireless communication device may move to an O-Primary subchannel and perform a transmission via the O-Primary subchannel. Alternatively, in accordance with a spatial reuse communication mode, in examples in which an OBSS transmission is heard (such as detected), a wireless communication device may ignore the OBSS transmission and perform a transmission on top of (such as via a same one or more subchannels and during an at least partially overlapping time period) the ongoing OBSS transmission in examples in which one or more conditions (such as criteria) are satisfied. In other words, a multi-primary channel communication mode and a spatial reuse communication mode may indicate a wireless communication device to perform different and non-compatible actions upon detection of an OBSS transmission.

In examples in which a wireless communication device is capable of both multi-primary channel access and spatial reuse, and in examples in which the multi-primary channel communication mode is enabled (such as activated), the wireless communication device may switch to an O-Primary subchannel (such as always switch to the O-Primary subchannel) and refrain from attempting spatial reuse in association with hearing an OBSS transmission. In some scenarios, however, spatial reuse may provide higher performance than an O-Primary subchannel transmission. Such higher performance may refer to lower latency, higher data rates, greater throughput, greater signal strength, shorter processing time, and/or less battery consumption associated with primary subchannel switching. Such scenarios may include relatively high SINR scenarios (such as high SINR operating regions) in which a transmitter device and a receiver device are at a low pathloss to each other (such that a signal strength between the transmitter device and the receiver device is relatively high) and/or in which a receiver and an OBSS device are at a high pathloss to each other (such that OBSS interference at the receiver is relatively low).

In some implementations of the present disclosure, a wireless communication device may dynamically control or configure scenarios in which to employ a multi-primary channel communication mode and scenarios in which to employ a spatial reuse communication mode to achieve relatively greater utilization of link capacity. In other words, in accordance with some of the example implementations disclosed herein, a wireless communication device may support one or more configuration- or signaling-based mechanisms according to which the wireless communication device selects whether to communicate in accordance with (such as using or employing) a multi-primary channel communication mode or a spatial reuse communication mode. In accordance with such configuration- or signaling-based mechanisms, wireless communication devices may dynamically achieve relatively more of an available link capacity.

In some aspects, such one or more configuration- or signaling-based mechanisms may relate to a (signaled) threshold value. In such aspects, a wireless communication device may compare, for example, at least one signal strength measurement to the threshold value and select whether to use the multi-primary channel communication mode or the spatial reuse communication mode in accordance with whether the signal strength measurement(s) satisfy the threshold value. Thus, the wireless communication device may be able to more fully and accurately account for differences in link RSSI (such as in-BSS RSSI) and OBSS RSSI to determine whether a spatial reuse transmission can be attempted.

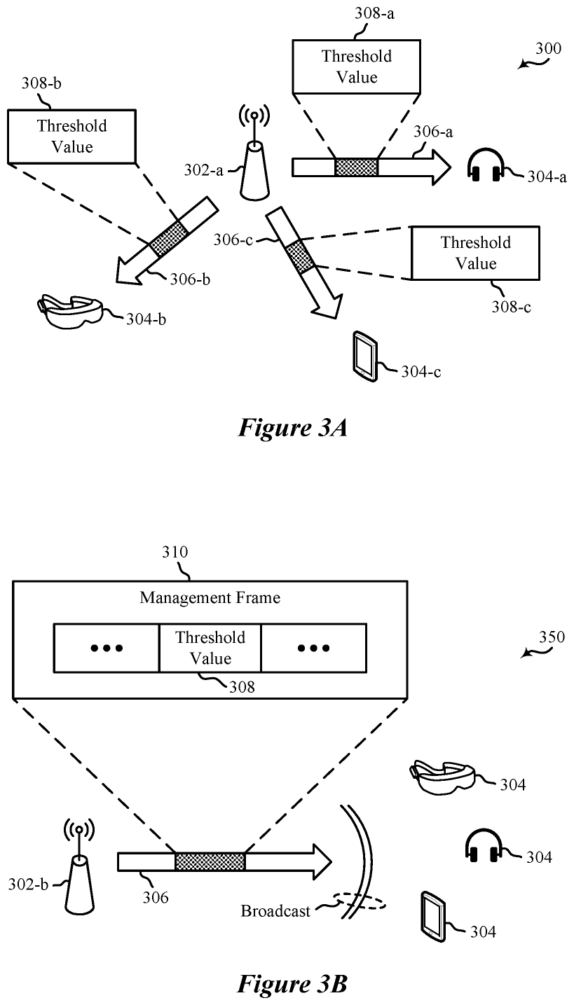

FIG. 3A shows an example signaling diagram 300 that supports signal strength-based selection between spatial reuse or multi-primary channel communication modes. The signaling diagram 300 may implement or be implemented to realize one or more aspects of the wireless communication network 100 or the wireless communication network 200. For example, the signaling diagram 300 illustrates communication between an AP 302-a, a STA 304-a, a STA 304-b, and a STA 304-c, which may be examples of corresponding devices described herein, including with reference to FIGS. 1 and 2. For example, the AP 302-a may be an example of an AP 102 or an AP 202 as illustrated by and described with reference to FIGS. 1 and 2, respectively. For further example, the STA 304-a, the STA 304-b, and the STA 304-c may be examples of STAs 104 or STAs 204 as illustrated by and described with reference to FIGS. 1 and 2, respectively.

The AP 302-a, the STA 304-a, the STA 304-b, and the STA 304-c may support one or more configuration- or signaling-based mechanisms according to which such wireless communication devices may dynamically select between communicating in accordance with a multi-primary channel communication mode or a spatial reuse communication mode. In some implementations, the AP 302-a may announce a threshold value to the STA 304-a, the STA 304-b, and the STA 304-c (such as client devices associated with the AP 302-a) and the threshold value may indicate information associated with examples in which to use the multi-primary channel communication mode and examples in which to use the spatial reuse communication mode. The AP 302-a may update the threshold value on a semi-static or dynamic basis. Additionally, or alternatively, the AP 302-a may indicate a threshold value on a per client basis (such that a threshold value is separately defined or indicated to each client device) and, in some aspects, the indicated threshold value may be different to different client devices. For example, a first client device may receive an indication of a first threshold value and a second client device may receive an indication of a second threshold value, with the first threshold value being the same as or different than the second threshold value.

As illustrated in the example of the signaling diagram 300, the AP 302-a may transmit an indication of a threshold value 308-a to the STA 304-a via a communication link 306-a, may transmit an indication of a threshold value 308-b to the STA 304-b via a communication link 306-b, and may transmit an indication of a threshold value 308-c to the STA 304-c via a communication link 306-c. The threshold value 308-a, the threshold value 308-b, and the threshold value 308-c may each be different than each other, may be partially the same (such that, for example, two of the three are the same), or may all be the same. In implementations in which the AP 302-a indicates threshold values on a per client basis, the AP 302-a may transmit the indications of the threshold values via specific signaling types that are relatively more suitable for indicating threshold values on a per client basis. In some aspects, the AP 302-a and one or more of the STA 304-a, the STA 304-b, and the STA 304-c may negotiate on their respectively assigned or indicated threshold values (such as via one or more frame exchanges, such as via one or more frame transmissions and/or receptions).

In some examples, the AP 302-a may transmit (such as announce) the threshold values via (re-)association response frames that the AP 302-a may transmit via unicast signaling to each associated STA. Such use of (re-)association response frames to convey or provide indications of threshold values may be suitable in scenarios in which the AP 302-a indicates different threshold values (such as different policies) to different STAs. Additionally, or alternatively, the AP 302-a may transmit the threshold values via one or more aggregated control (A-Control) fields sent via one or more management or data frames or via one or more action frames. Such use of an A-Control field in a management or data frame or an action frame to convey or provide an indication of a threshold value may be suitable in scenarios in which the AP 302-a indicates different threshold values to different STAs. In accordance with the signaling diagram 300, the AP 302-a may control associated wireless communication devices, including examples in which to allow multi-primary channel access and examples in which to perform spatial reuse.

FIG. 3B shows an example signaling diagram 350 that supports signal strength-based selection between spatial reuse or multi-primary channel communication modes. The signaling diagram 350 may implement or be implemented to realize one or more aspects of the wireless communication network 100 or the wireless communication network 200. For example, the signaling diagram 350 illustrates communication between an AP 302-b and a set of STAs 304 via a wireless communication link 306, which may be examples of corresponding devices described herein, including with reference to FIGS. 1 and 2. For example, the AP 302-b may be an example of an AP 102 or an AP 202 as illustrated by and described with reference to FIGS. 1 and 2, respectively. For further example, the STAs 304 may be examples of STAs 104 or STAs 204 as illustrated by and described with reference to FIGS. 1 and 2, respectively.

The AP 302-b and the set of STAs 304 may support one or more configuration- or signaling-based mechanisms according to which such wireless communication devices may dynamically select between communicating using a multi-primary channel communication mode or a spatial reuse communication mode. In some implementations, the AP 302-b may announce a threshold value 308 to the STAs 304 (such as client devices associated with the AP 302-b) and the threshold value 308 may indicate information associated with examples in which to use the multi-primary channel communication mode and examples in which to use the spatial reuse communication mode. The AP 302-b may update the threshold value 308 on a semi-static or dynamic basis. Additionally, or alternatively, the AP 302-b may indicate a same threshold value 308 for the set of STAs 304 (such that the threshold value 308 is not indicated on a per client basis).

As illustrated in the example of the signaling diagram 350, the AP 302-b may transmit an indication of the threshold value 308 via a management frame 310 that is sent to, and received by, the set of STAs 304. For example, the management frame 310 may be an example of a broadcast management frame that the AP 302-b broadcasts to multiple STAs (including the set of STAs 304). In such examples, the management frame 310 may be a beacon frame, a probe response frame, or any other frame that the AP 302-b might broadcast to potentially multiple receivers. Such use of a broadcast management frame may be suitable in scenarios in which the same threshold value 308 (such as the same policy) applies to the set of STAs 304 (such as to all or at least a subset of multiple STAs associated with the AP 302-b). In accordance with the signaling diagram 350, the AP 302-a may control associated wireless communication devices, including examples in which to allow multi-primary channel access and examples in which to perform spatial reuse.

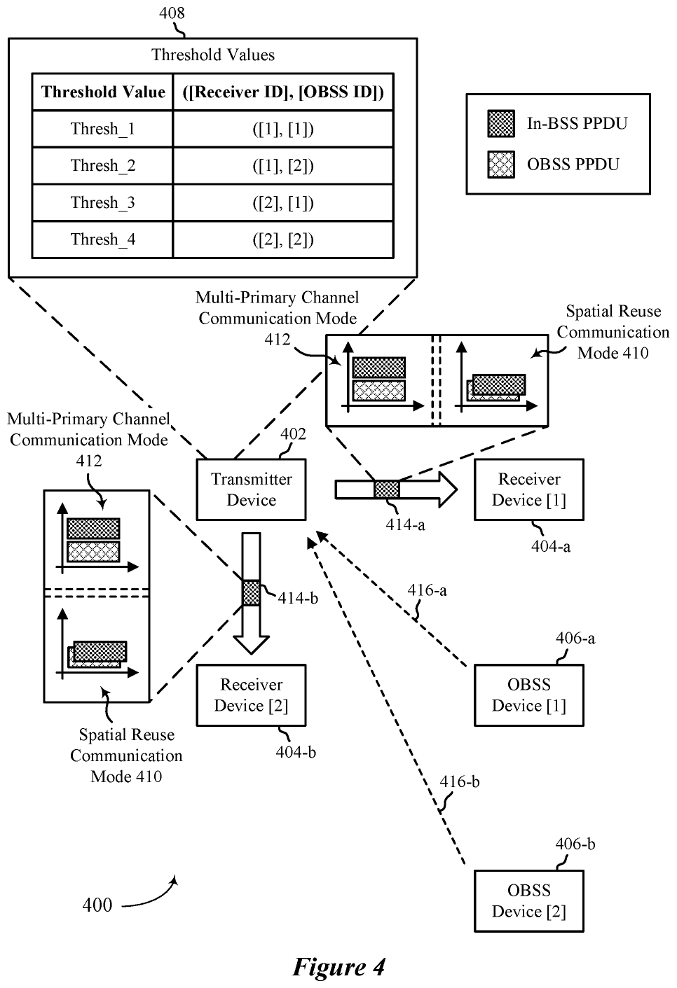

FIG. 4 shows an example signaling diagram 400 that supports signal strength-based selection between spatial reuse or multi-primary channel communication modes. The signaling diagram 400 may implement or be implemented to realize one or more aspects of the wireless communication network 100, the wireless communication network 200, the signaling diagram 300, or the signaling diagram 350. For example, the signaling diagram 400 illustrates communication between a transmitter device 402, a receiver device 404-a, and a receiver device 404-b. The signaling diagram 400 further illustrates an OBSS device 406-a and an OBSS device 406-b, which may cause interference to or experience interference from transmissions by the transmitter device 402.

The transmitter device 402, the receiver device 404-a, the receiver device 404-b, the OBSS device 406-a, and the OBSS device 406-b may be examples of any wireless communication devices described herein, such as one or more APs and/or one or more STAs. The receiver device 404-a may be associated with a first receiver identifier (ID) (such as a receiver ID of “[1]”) and the receiver device 404-b may be associated with a second receiver ID (such as a receiver ID of “[2]”). The OBSS device 406-a and the OBSS device 406-b may be associated with different BSSs (such as different OBSSs from the perspective of the transmitter device 402). For example, the OBSS device 406-a may be associated with a first OBSS ID (such as an OBSS ID of “[1]”) and the OBSS device 406-b may be associated with a second OBSS ID (such as an OBSS ID of “[2]”).

In some aspects, the OBSS device 406-a and the OBSS device 406-b may cause interference to (or at least measurable at) the transmitter device 402. For example, the OBSS device 406-a may cause interference 416-a to the transmitter device 402. For further example, the OBSS device 406-b may cause interference 416-b to the transmitter device 402. In some aspects, the receiver device 404-a and/or the receiver device 404-b also may experience the interference 416-a and/or the interference 416-b from the OBSS device 406-a and the OBSS device 406-b, respectively. In some deployment scenarios, the receiver device 404-a and/or the receiver device 404-b may experience the interference 416-a and/or the interference 416-b at different magnitudes as compared to how the transmitter device 402 experiences the interference 416-a and/or the interference 416-b.

In accordance with some example implementations, one or more of the transmitter device 402, the receiver device 404-a, and the receiver device 404-b may communicate (such as transmit and/or receive) an indication of a threshold value 408 associated with a selection between a spatial reuse communication mode 410 or a multi-primary channel communication mode 412. For example, an AP (which may be any one of the transmitter device 402, the receiver device 404-a, or the receiver device 404-b) may unicast and/or broadcast one or more indications of one or more threshold values 408 and STAs (such as any one or more of the transmitter device 402, the receiver device 404-a, or the receiver device 404-b) may receive at least one indication of at least one threshold value 408. The AP and the STAs (including the transmitter device 402, the receiver device 404-a, or the receiver device 404-b) may communicate using the spatial reuse communication mode 410 or the multi-primary channel communication mode 412 in accordance with at least one threshold value 408.

A threshold value 408 may be an example of any one or more of a threshold value 308, a threshold value 308-a, a threshold value 308-b, or a threshold value 308-c as illustrated by and described with reference to FIGS. 3A and 3B. In some implementations, a threshold value 408 may be associated with a threshold that indicates examples in which a wireless communication device is able, allowed, or expected to use the multi-primary channel communication mode 412 and perform O-Primary subchannel access. In other words, the transmitter device 402, the receiver device 404-a, and the receiver device 404-b may support an O-Primary subchannel access rule that indicates that a wireless communication device is (able, allowed, or expected) to switch to an O-Primary subchannel (such as to communicate in accordance with the multi-primary channel communication mode 412) in examples in which a criteria associated with a threshold value 408 is satisfied.

Such a criteria associated with the threshold value 408 may involve or correspond to one or multiple signal strength measurements at a wireless communication device. In some examples, a wireless communication device may compare a single signal strength measurement to a threshold value 408. The single signal strength measurement may be an interference measurement at the wireless communication device, which may be referred to or understood as an OBSS_RSSI. In such examples, the O-Primary subchannel access rule may indicate that the wireless communication device is to use the spatial reuse communication mode 410 in examples in which the single signal strength measurement is less than or equal to the threshold value 408 and is to use the multi-primary channel communication mode 412 in examples in which the single signal strength measurement is greater than the threshold value 408.

Additionally, or alternatively, a wireless communication device may compare multiple signal strength measurements to a threshold value 408. The multiple signal strength measurements may include a first signal strength measurement and a second signal strength measurement. The first signal strength measurement may be an interference measurement at the wireless communication device (such as an OBSS_RSSI) and the second signal strength measurement may be associated with a packet (such as an RSSI of the packet) received from a second wireless communication device with which the wireless communication device expects to communicate. In other words, as used herein, “OBSS_RSSI” may be understood as a strength of an OBSS reception at a wireless communication device and “RSSI” may be understood as a strength of a packet received from an in-BSS wireless communication (such as a signal strength of a most recently received packet from the second wireless communication device with which the wireless communication device expects to communicate).

The wireless communication device may compare the first signal strength measurement (such as the OBSS_RSSI) and the second signal strength measurement (such as the RSSI, which may be equivalently understood as an in-BSS_RSSI or a link RSSI) in accordance with comparing a difference between the first signal strength measurement and the second signal strength measurement to the threshold value 408. For example, the wireless communication device may compare a difference of (RSSI-OBSS_RSSI) to the threshold value 408. In such examples, the wireless communication device may use the spatial reuse communication mode 410 in examples in which the difference is greater than or equal to the threshold value 408 and may use the multi-primary channel communication mode 412 in examples in which the difference is less than the threshold value 408. In other words, the O-Primary subchannel access rule may indicate that a wireless communication device is to switch to an O-Primary subchannel in examples in which (and, in some aspects, only if) RSSI-OBSS_RSSI<Primary_Switch_Thresh, with “Primary_Switch_Thresh” being an example value of a threshold value 408. Otherwise, the O-Primary subchannel access rule may indicate that a wireless communication device is to remain on an M-Primary subchannel and use the spatial reuse communication mode 410 (such as to attempt to perform a spatial reuse transmission).

For example, in examples in which a first BSS associated with a first BSS bandwidth (such as 20 MHz) and a second BSS associated with a second BSS bandwidth (such as 40 MHz) operate at a reference SNR of 25 decibels (dB), transmissions by the two BSSs (which may be OBSSs relative to each other) may be associated with a TDMA wireless communication scheme in accordance with a multi-primary channel communication mode, which may potentially inefficiently use available link capacity. With spatial reuse, which may increase usage of available link capacity in such examples, the transmissions by the two BSSs may overlap with each other and, as a result, an operating SINR may depend on a strength of an OBSS RSSI with respect to (such as relative to) an in-BSS RSSI. Further, in such examples, different regions of SINR may be associated with differing indications of whether spatial reuse or multi-primary channel access would result in a greater utilization of available link capacity. In accordance with some example implementations, a threshold value 408 may be set to 18 dB such that, for SINR less than 18, a multi-primary channel communication may provide greater utilization of available link capacity and, for SINR greater than or equal to 18 dB, a spatial reuse communication mode may provide greater utilization of available link capacity (among other potential benefits, such as lower latency and reduced power consumption by way of avoiding a channel switch).

In such an example in which the threshold value 408 is set to 18 dB, in examples in which RSSI is not stronger than OBSS_RSSI by at least 18 dB, SINR may fall below 18 dB and overall network throughput may drop in examples in which spatial reuse is attempted (such that multi-primary channel access may provide relatively greater network throughput, as compared to spatial reuse, in examples in which SINR is less than 18 dB). Alternatively, in examples in which RSSI is stronger than OBSS_RSSI by 18 dB or more, SINR may be greater than or equal to 18 dB and spatial reuse may provide relatively greater network throughput, as compared to multi-primary channel access.

In some implementations, the transmitter device 402 (or any other wireless communication device) may maintain (such as support, configure, initialize, track, and/or update) multiple threshold values 408. For example, the transmitter device 402 may maintain a respective threshold value 408 for each wireless communication device with which the transmitter device 402 may communicate (such as with each wireless communication device associated with the transmitter device 402) on a per-OBSS basis. In other words, the transmitter device 402 may maintain various threshold values 408 such that each threshold value 408 is associated with a value identifiable as Primary_Switch_Thresh([receiver_ID], [OBSS_ID]).

For example, the transmitter device 402 may maintain a first threshold value 408 (such as “Thresh_1”) for communication with the receiver device 404-a (associated with a receiver ID of “[1]”) and interference from the first OBSS (associated with the OBSS ID of “[1]”). For further example, the transmitter device 402 may maintain a second threshold value 408 (such as “Thresh_2”) for communication with the receiver device 404-a and interference from the second OBSS (associated with the OBSS ID of “[2]”). Additionally, in some examples, the transmitter device 402 may maintain a third threshold value 408 (such as “Thresh_3”) for communication with the receiver device 404-b (associated with a receiver ID of “[2]”) and interference from the first OBSS and a fourth threshold value 408 (such as “Thresh_4”) for communication with the receiver device 404-b and interference from the second OBSS. In other words, Primary_Switch_Thresh ([1], [1])=Thresh_1, Primary_Switch_Thresh ([1], [2])=Thresh_2, Primary_Switch_Thresh ([2], [1])=Thresh_3, and Primary_Switch_Thresh ([2], [2])=Thresh_4. Generally, the transmitter device 402 may maintain a respective threshold value 408 for each ([receiver_x], [OBSS_y]) combination or pair.

In some implementations, the transmitter device 402 may initialize the multiple threshold values 408 to one or more default (such as initial) values. In other words, the transmitter device 402 may set the first threshold value 408, the second threshold value 408, the third threshold value 408, and the fourth threshold value 408 to one or more default values. The one or more default values may correspond to the one or more threshold values 408 indicated or announced by an AP. In some aspects, the one or more default values may include a single default value, such as a single value indicated or announced by an AP for the transmitter device 402. Alternatively, the AP may indicate or announce multiple threshold values 408 for the transmitter device 402 and the transmitter device 402 may initialize the multiple threshold values 408 in accordance with the multiple threshold values 408 indicated or announced by the AP. In such examples, the AP may indicate, via a configured correspondence or via information provided along with the indications of the multiple threshold values 408, which indicated threshold value 408 corresponds to which ([receiver_ID], [OBSS_ID]) combination or pair.

The transmitter device 402 may communicate with the receiver device 404-a and the receiver device 404-b in accordance with maintaining the multiple threshold values 408. For example, in examples in which the transmitter device 402 expects (such as attempts or is scheduled) to communicate with the receiver device 404-a and in examples in which the transmitter device 402 detects the interference 416-a associated with an OBSS transmission from the first OBSS, the transmitter device 402 may use the spatial reuse communication mode 410 or the multi-primary channel communication mode 412 for the communication with the receiver device 404-a in accordance with the first threshold value 408 (such as Thresh_1). Such communication with the receiver device 404-a may include an attempt to transmit a PPDU 414-a to the receiver device 404-a. For further example, in examples in which the transmitter device 402 expects to communicate with the receiver device 404-b and in examples in which the transmitter device 402 detects the interference 416-a associated with an OBSS transmission from the first OBSS, the transmitter device 402 may use the spatial reuse communication mode 410 or the multi-primary channel communication mode 412 for the communication with the receiver device 404-b in accordance with the third threshold value 408 (such as Thresh_3). Such communication with the receiver device 404-b may include an attempt to transmit a PPDU 414-b to the receiver device 404-b.

In some scenarios, the transmitter device 402 and an intended receiver device may have difference views of OBSS interference. In other words, an asymmetric view of OBSS interference at the transmitter device 402 and the intended receiver device may arise (such as due to the transmitter device 402 and the intended receiver device being non-collocated). In some implementations, to address such scenarios, the transmitter device 402 may perform an outer loop correction scheme according to which the transmitter device 402 may update a threshold value 408 over time to maintain synchronization with an intended receiver device. In some aspects, the transmitter device 402 may perform such an outer loop correction scheme for each maintained threshold value 408 (such as for each receiver and on a per OBSS basis). Such an outer loop correction scheme may be associated with an updating of a threshold value 408 (such as to increase or decrease the threshold value 408) in accordance with a communication failure, or at least a failure of some criteria associated with communication, with the intended receiver device.

For example, in examples in which the transmitter device 402 intends to serve the receiver device 404-a and in examples in which the transmitter device 402 hears (such as detects) the first OBSS, the transmitter device 402 may select to use the spatial reuse communication mode 410 or the multi-primary channel communication mode 412 for communication with the receiver device 404-a in accordance with the first threshold value 408 (such as Thresh_1). The transmitter device 402 may communicate using the selected one of the spatial reuse communication mode 410 or the multi-primary channel communication mode 412 (in accordance with whether (RSSI-OBSS_RSSI)<Thresh_1 or (RSSI-OBSS_RSSI)>Thresh_1) and, in examples in which the communication fails a criteria, the transmitter device 402 may increase or decrease the value of Thresh_1. The transmitter device 402 may increase or decrease the value of Thresh_1 in accordance with an assumption, expectation, or determination that the receiver device 404-a likely sees different (such as larger or smaller) interference from the first OBSS than the transmitter device 402.

In an example, in examples in which the transmitter device 402 determines that (RSSI-OBSS_RSSI)<Thresh_1 (where “RSSI” is associated with a communication link between the transmitter device 402 and the receiver device 404-a and “OBSS_RSSI” is the RSSI between the transmitter device 402 and the first OBSS, such as the OBSS device 406-a), the transmitter device 402 may move to an O-Primary subchannel and attempt to communicate with the receiver device 404-a via the O-Primary subchannel. Such communication may involve a transmission, by the transmitter device 402, of one or more request-to-send (RTS) frames. In examples in which the one or more RTS frames fail a reception criteria (such as a criteria associated with reception of the one or more RTS frames), the transmitter device 402 may decrease the value of Thresh_1 by a delta value. Alternatively, in examples in which the 402 determines that (RSSI-OBSS_RSSI)>Thresh_1, the transmitter device 402 may refrain from moving to the O-Primary subchannel and attempt to communicate with the receiver device 404-a using the spatial reuse communication mode 410. Such communication may involve a transmission, by the transmitter device 402, of one or more RTS frames. In examples in which the one or more RTS frames fail a reception criteria (such as a criteria associated with reception of the one or more RTS frames), the transmitter device 402 may increase the value of Thresh_1 by a delta value.

Alternatively, in examples in which the transmitter device 402 compares the first threshold value 408 Thresh_1 to a single signal strength measurement (such as the OBSS_RSSI), the transmitter device 402 may increase the value of Thresh_1 by a delta value in examples in which one or more RTS frames sent via the O-Primary subchannel (in accordance with a selection of the multi-primary channel communication mode 412 in view of the single signal strength measurement of OBSS_RSSI) fail a reception criteria. Further, and also in examples in which the transmitter device 402 compares the first threshold value 408 Thresh_1 to a single signal strength measurement (such as the OBSS_RSSI), the transmitter device 402 may decrease the value of Thresh_1 by a delta value in examples in which one or more RTS frames sent in accordance with the spatial reuse communication mode 410 fail a reception criteria.

Such a reception criteria may be associated with a (single) failure to receive a clear-to-send (CTS) frame associated with (such as responsive to) an RTS frame, a failure to receive a CTS frame associated with (such as responsive to) a threshold quantity of RTS frames, and/or a failure to receive a CTS frame associated with one or more RTS frames over a time window, among other examples. Such a delta value may be signaled by an AP or may be otherwise configured at the transmitter device 402. Further, the delta value may be a static (such as fixed) value or may scale up or down (linearly, exponentially, or in any other way) over time. For example, in some aspects, the transmitter device 402 may increase (linearly, stepwise (within a set of possible delta values), or exponentially) the delta value in accordance with each (consecutive) failure to satisfy the reception criteria. Additionally, or alternatively, the transmitter device 402 may decrease (linearly, stepwise (within a set of possible delta values), or exponentially) the delta value in accordance with each (consecutive) satisfaction of the reception criteria.

A wireless communication device (such as an AP or the transmitter device 402) may select (such as determine, calculate, identify, or ascertain) a threshold value 408, such as an initial or default value for a threshold value 408, in accordance with one or more mechanisms. Such selection may be in addition to (such as prior to) a signaling of the threshold value 408 or may be separate from a signaling of the threshold value 408 (such that the wireless communication device may use a (self-)selected threshold value 408 in addition to, or as an alternative to, any transmission or reception of a threshold value 408 by or at the wireless communication device). For example, in some implementations, an AP may announce one or more threshold values 408 to one or more STAs and, instead of using the announced threshold values 408, the AP may use one or more different threshold values 408 (that the AP may not announce to the STAs associated with the AP). Additionally, or alternatively, STAs may use one or more threshold values 408 without signaling from an AP (such as in accordance with a network specification). In such implementations, an AP may signal one or more threshold values 408 to override the values used at the STAs (such as to override default or baseline values provided by the network specification).

In some examples, the wireless communication device may estimate an achievable rate (such as data rate) associated with a TDM transmission. In such examples, the wireless communication device may estimate the achievable rate at a specific SNR, such as an SNR associated with a difference of (RSSI−noise floor), as Rate_TDM. The wireless communication device may estimate such a Rate_TDM at a bandwidth of or associated with an O-Primary subchannel. The wireless communication device may additionally estimate an achievable rate (such as data rate) associated with a spatial ruse transmission. The wireless communication device may estimate the achievable rate at a specific SINR, such as an SINR associated with a difference of (RSSI−IRSSI), as Rate_SR, with “IRSSI” being understood as an interferer's RSSI. The wireless communication device may estimate such a Rate_SR at a bandwidth of or associated with a combined bandwidth (including, for example, at least an M-Primary subchannel and an O-Primary subchannel). In some implementations, the wireless communication device may select the threshold value 408 in accordance with Primary_Switch_Thresh=SINR (RSSI−IRSSI) such that Rate_SR>Rate_TDM.

In some aspects, the wireless communication device may track RSSI over time. In such aspects, the RSSI that the wireless communication device uses to select (such as calculate or compute) a threshold value 408 may a signal strength of a last received (such as most recently received, or received within a threshold time duration) packet at the wireless communication device. Additionally, or alternatively, the RSSI that the wireless communication device uses to calculate a threshold value 408 may be a signal strength of a beacon frame sent by an associated AP. For example, in examples in which the wireless communication device is a STA, the STA may use the beacon of an associated AP to measure an RSSI that the wireless communication device may use in the selection of a threshold value 408.

In accordance with such rules associated with whether to use the spatial reuse communication mode 410 or the multi-primary channel communication mode 412, a wireless communication device may be relatively more likely to use the multi-primary channel communication mode 412 in scenarios in which OBSS is heard (such as detected) strong relative to own packet reception (which may be indicative of scenarios in which interference is strong) and may be relatively more likely to use the spatial reuse communication mode 410 in scenarios in which OBSS is heard weak relative to own packet reception (which may be indicative of scenarios in which interference is weak). Such a relative difference between in-BSS signal strength and interference (such as OBSS interference) at which a wireless communication device switches between the spatial reuse communication mode 410 and the multi-primary channel communication mode 412 may be determined (such as defined, indicated, specified, selected, or provided) by a threshold value 408.

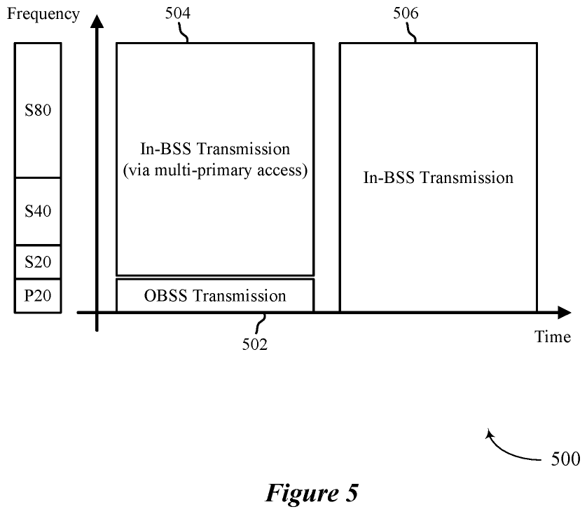

FIG. 5 shows an example communication timeline 500 associated with a signal strength-based selection of a multi-primary channel communication mode. The communication timeline 500 may implement or be implemented to realize one or more aspects of the wireless communication network 100, the wireless communication network 200, the signaling diagram 300, the signaling diagram 350, or the signaling diagram 400. For example, the communication timeline 500 illustrates a sequence of transmissions (such as communication) involving two or more wireless communication devices, such as any two or more of the wireless communication devices illustrated by and described with reference to FIGS. 1-4.

In accordance with the communication timeline 500, a wireless communication device may select to attempt to communicate with another wireless communication using a multi-primary channel communication mode (such as the multi-primary channel communication mode 412 as illustrated by and described with reference to FIG. 4) in accordance with a threshold value associated with a selection between a spatial reuse communication mode and the multi-primary channel communication mode (and at least one signal strength measurement). Such a threshold value may be an example of a threshold value 308, a threshold value 308-a, a threshold value 308-b, a threshold value 308-c, or a threshold value 408 as illustrated by and described with reference to FIGS. 3A, 3B, and 4. For example, the wireless communication device may detect an OBSS transmission 502 via an M-Primary subchannel (such as an M-Primary 20 MHz subchannel, such as a P20 MHz subchannel) and, in accordance with the threshold value and at least one signal strength measurement, may select to switch to an O-Primary subchannel and attempt to communicate using a multi-primary channel communication mode.

In such examples, the wireless communication device may perform an in-BSS transmission 504 via (such as using or in accordance with the multi-primary channel communication mode). In accordance with the multi-primary channel communication mode, the wireless communication device may perform the in-BSS transmission 504 via one or more of a secondary 20 MHz subchannel (such as an S20 MHz subchannel), a secondary 40 MHz channel (such as an S40 MHz channel), or a secondary 80 MHz channel (such as an S80 MHz channel). Upon completion of the OBSS transmission 502, a duration of which the wireless communication device may obtain information via detection of the OBSS transmission 502 (such as via a partial decoding or parsing of the OBSS transmission 502, such as via a decoding or parsing of a preamble portion of the OBSS transmission 502), the wireless communication device may perform an in-BSS transmission 506 via a full bandwidth (such as a full 320 MHz bandwidth).

In some deployment scenarios, for example, Wi-Fi networks may support large or wide bandwidth operation, with one 20 MHz subchannel within the operating bandwidth designated as a primary subchannel. Wi-Fi nodes (such as any one or more of the wireless communication devices illustrated by and described with reference to FIGS. 1-4) may contend for medium access associated with the primary subchannel. In examples in which an OBSS (such as the OBSS transmission 502) occupies the primary subchannel, a remainder of the operating bandwidth may remain unutilized in examples in which the OBSS does not support wide bandwidth operation, which may result in inefficient utilization of the medium. Thus, in some implementations, one or more wireless communication devices may support multi-primary channel access (such as NPCA) according to which a wireless communication device (such as an ultra-high reliability (UHR) capable wireless communication device) may monitor additional 20 MHz subchannels (such as one or more O-Primary 20 MHz subchannels). In accordance with some of the example implementations disclosed herein, a (UHR capable) wireless communication device may selectively employ multi-primary channel access (such as NPCA) in accordance with a threshold value associated with a selection between a spatial reuse communication mode or a multi-primary channel communication mode.

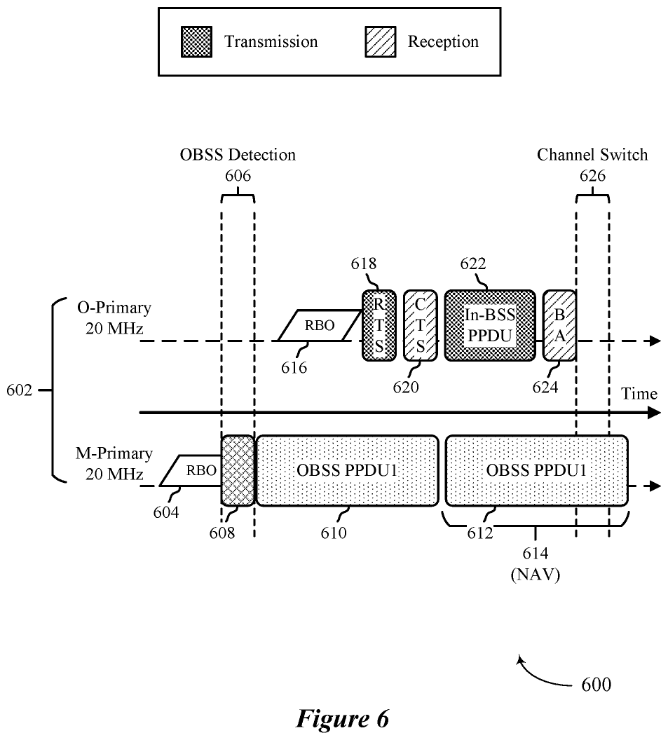

FIG. 6 shows an example communication timeline 600 associated with a signal strength-based selection of a multi-primary channel communication mode. The communication timeline 600 may implement or be implemented to realize one or more aspects of the wireless communication network 100, the wireless communication network 200, the signaling diagram 300, the signaling diagram 350, the signaling diagram 400, or the communication timeline 500. For example, the communication timeline 600 illustrates a frame exchange sequence (such as communication) involving two or more wireless communication devices, such as any two or more of the wireless communication devices illustrated by and described with reference to FIGS. 1-5.

In accordance with the communication timeline 600, a wireless communication device may support a combined bandwidth 602 including at least an M-Primary 20 MHz subchannel and an O-Primary 20 MHz subchannel. The M-Primary 20 MHz subchannel may be understood as a baseline primary subchannel and the O-Primary 20 MHz subchannel may be understood as an opportunistically used/available primary subchannel in addition to the M-Primary 20 MHz subchannel. To support or obtain O-Primary subchannel access, a wireless communication device (which may be a receiver device or a transmitter device) may monitor the M-Primary subchannel and the O-Primary subchannel, either sequentially or in parallel (depending on a hardware capability of the wireless communication device) and the wireless communication device may contend and transmit via the O-Primary subchannel in examples in which the wireless communication device senses (such as detects) the M-Primary subchannel to be busy.

For example, in examples in which an OBSS wireless communication device obtains access to the M-Primary subchannel in accordance with an RBO 604, the OBSS wireless communication device may transmit via the M-Primary subchannel and, accordingly, the wireless communication device perform an OBSS detection 606. The wireless communication device may hear the OBSS by way of receiving a frame 608 and/or by way of receiving (such as sensing or measuring) interference associated with the frame 608. In some aspects, the frame 608 may be an RTS frame. In accordance with the OBSS detection 606, the wireless communication device may switch to the O-Primary subchannel. The wireless communication device may remain on the O-Primary subchannel for a duration associated with a channel access time (such as a TXOP) of the OBSS wireless communication device. For example, the wireless communication device may remain on the O-Primary subchannel while the OBSS wireless communication device transmits an OBSS PPDU 610 and/or an OBSS PPDU 612 (one or both of which may be associated with a NAV 614 indicated by, for example, the frame 608, with the one or more NAVs 614 indicating lengths or durations associated with one or both of the OBSS PPDU 610 or the OBSS PPDU 612). In other words, the wireless communication device (which may be either the receiver device or the transmitter device) may remain on the O-Primary subchannel for (at least) a duration of NAV set by the OBSS.

In examples in which the wireless communication device is a transmitter device, the wireless communication device may contend for medium access via the O-Primary subchannel in accordance with an RBO 616 and may start (such as begin) transmission in accordance with obtaining medium access. For example, the wireless communication device, after the RBO 616, may transmit an RTS frame 618 via the O-Primary subchannel. A receiver device may receive the RTS frame 618 and transmit a CTS frame 620 associated with (such as responsive to) the RTS frame 618. In examples in which the receive device does not successfully receive the RTS frame 618 (such as in accordance with a selection of a spatial reuse communication mode at the receiver device, the wireless communication device may fail to satisfy a criteria associated with a reception of the CTS frame 620. Otherwise, in examples in which the wireless communication device successfully receives the CTS frame 620 from the receiver device, the wireless communication device may transmit an in-BSS PPDU 622 to the receiver device. In examples in which the receiver device successfully receives the in-BSS PPDU 622, the receiver device may transmit a block acknowledgment (BA) 624. Such a BA 624 may convey or provide feedback associated with the in-BSS PPDU 622.

In some implementations, the wireless communication device (either the receiver device or the transmitter device) may perform a channel switch 626 to return to the M-Primary subchannel. In some examples, the wireless communication device may return to the M-Primary subchannel via the channel switch 626 in accordance with an expiration of the NAV set by the OBSS. In other words, the wireless communication device may switch back to the M-Primary subchannel in accordance with determining, calculating, identifying, assuming, or expecting that the OBSS transmissions (including the OBSS PPDU 610 and/or the OBSS PPDU 612) are completed. In some other examples, the wireless communication device may return to the M-Primary subchannel via the channel switch 626 in accordance with completion of the in-BSS PPDU 622.

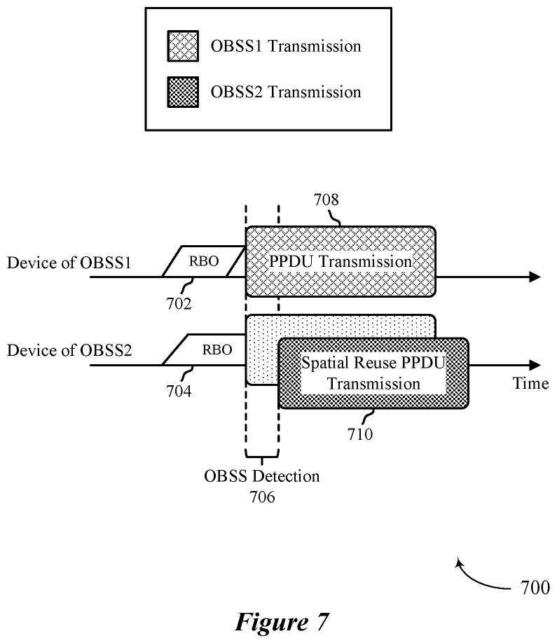

FIG. 7 shows an example communication timeline 700 associated with a signal strength-based selection of a spatial reuse communication mode. The communication timeline 700 may implement or be implemented to realize one or more aspects of the wireless communication network 100, the wireless communication network 200, the signaling diagram 300, the signaling diagram 350, or the signaling diagram 400. For example, the communication timeline 700 illustrates a transmission sequence (such as communication) involving two or more wireless communication devices, such as any two or more of the wireless communication devices illustrated by and described with reference to FIGS. 1-4.

In accordance with the communication timeline 700, a wireless communication device may select to use a spatial reuse communication mode in accordance with a threshold value associated with a selection between the spatial reuse communication mode and a multi-primary channel communication mode. The spatial reuse communication mode may be associated with a communication mode or mechanism that allows multiple wireless communication devices to occupy a same medium concurrently (such as simultaneously), which may increase overall network capacity. For example, without spatial reuse, a wireless communication device, in accordance with hearing, detecting, or sensing an OBSS transmission, may classify the medium as busy and defer a transmission until the ongoing OBSS transmission ends.

Alternatively, with spatial reuse, a wireless communication device may transmit over (such as via an at least partially overlapping channel and during an at least partially overlapping time period) the ongoing OBSS transmission in examples in which a set of conditions or criteria are satisfied. In other words, in accordance with a spatial reuse communication mode, the wireless communication device may perform an overlapping transmission in examples in which the set of conditions or criteria are satisfied and may otherwise defer the transmission until the ongoing OBSS transmission ends. Such conditions or criteria may be associated with an interference level likely caused to the ongoing OBSS transmission. For example, in examples in which a potential spatial reuse transmission is likely to cause equal to or greater than a threshold amount of interference, the wireless communication device may defer the transmission (and, potentially, ultimately not actually perform spatial reuse). Alternatively, in examples in which the potential spatial reuse transmission is likely to cause less than a threshold amount of interference, the wireless communication device may perform the spatial reuse transmission. In some aspects, a spatial reuse communication mode may further specify one or more mechanisms or parameters according to which the wireless communication device may apply a transmit power reduction to perform a spatial reuse transmission. Thus, using a spatial reuse communication mode may include both spatial reuse communication or TDD communication (if a transmission is deferred and spatial reuse is not employed) and may be associated with at least an attempt to perform spatial reuse.

As illustrated in the example of the communication timeline 700, a first wireless communication device (such as a first wireless node) of a first OBSS (such as OBSS1) and a second wireless communication device (such as a second wireless node) of a second OBSS (such as OBSS2) may perform spatial reuse in accordance with a selection between the spatial reuse communication mode and the multi-primary channel communication mode. In an example, the first wireless communication may obtain medium access in accordance with an RBO 702 and, at some point afterwards, the second wireless communication device may obtain medium access in accordance with an RBO 704. In accordance with the selection of the spatial reuse communication mode, the second wireless communication device may stay on the same subchannel as that which the first wireless communication device obtained access and may determine whether spatial reuse is allowed.

For example, the second wireless communication device may detect, in accordance with an OBSS detection 706, the PPDU transmission 708 by the first wireless communication device (an OBSS transmission from the perspective of the second wireless communication device) and, in accordance with the selection of the spatial reuse communication mode at the second wireless communication device, may determine whether the second wireless communication device is allowed to perform a spatial reuse PPDU transmission 710. In examples in which the second wireless communication device determines that one or more conditions or criteria associated with spatial reuse are satisfied, the second wireless communication device may perform the spatial reuse PPDU transmission 710. Alternatively, in examples in which the second wireless communication device determines that one or more conditions or criteria associated with spatial reuse are not satisfied, the second wireless communication device may refrain from performing the spatial reuse PPDU transmission 710 (and may instead transmit a different PPDU at a later time, such as once the medium is idle or once the one or more conditions or criteria associated with spatial reuse are satisfied).

In some implementations, the threshold value associated with the selection between the spatial reuse communication mode and the multi-primary channel communication mode may be a threshold value associated with the one or more conditions or criteria associated with spatial reuse. For example, various (UHR capable) wireless communication devices may support an additional interpretation of a threshold value associated with whether spatial reuse is allowed. Such an additional interpretation may be an UHR-specific interpretation. In such examples, the UHR capable) wireless communication devices may interpret a threshold value configured for (such as conditioning or allowing) spatial reuse as, additionally, the threshold value associated with the selection between the spatial reuse communication mode and the multi-primary channel communication mode. In such implementations, a wireless communication device may perform spatial reuse in examples in which the threshold value is satisfied and may perform multi-primary channel access (such as NPCA) in examples in which the threshold is not satisfied.

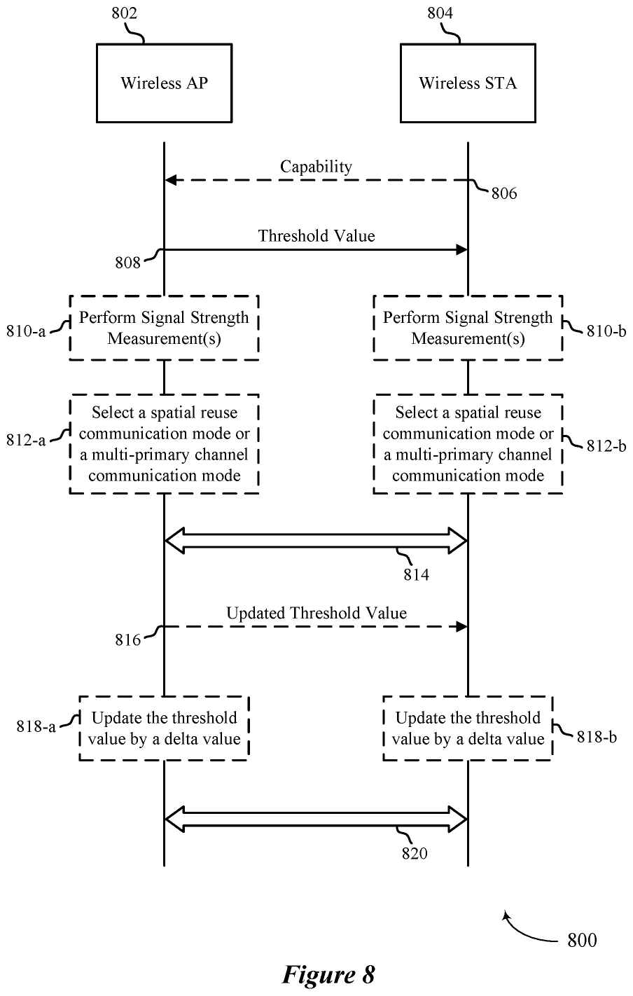

FIG. 8 shows an example process flow 800 that supports signal strength-based selection between spatial reuse or multi-primary channel communication modes. The process flow 800 may implement or be implemented to realize one or more aspects of the wireless communication network 100, the wireless communication network 200, the signaling diagram 300, the signaling diagram 350, the signaling diagram 400, the communication timeline 500, the communication timeline 600, or the communication timeline 700. For example, the process flow 800 illustrates communication between an AP 802 and a STA 804, which may be examples of APs and STAs, or any other wireless communication devices, as illustrated by and described with reference to FIGS. 1-7.

In the following description of process flow 800, the operations between the AP 802 and the STA 804 may be performed in a different order than the order shown, or other operations may be added or removed from the process flow 800. For example, some operations also may be left out of process flow 800, or may be performed in different orders or at different times. Further, although some operations or signaling may be shown to occur at different times for discussion purposes, these operations may actually occur at the same time. Although the AP 802 and the STA 804 are shown performing the operations of process flow 800, some aspects of some operations also may be performed by one or more other wireless communication devices.

At 806, the AP 802 may receive, from the STA 804, information indicative of a capability of the STA 804 to support a selection between a spatial reuse communication mode or a multi-primary channel communication mode. Additionally, or alternatively, the AP 802 may transmit, to the STA 804, information indicative of a capability of the AP 802 to support the selection between the spatial reuse communication mode or the multi-primary channel communication mode. The AP 802 and the STA 804 may exchange such capability information via one or more frames, such as one or more management frames, (re-)association frames, (re-)association response frames, action frames, data frames, or any combination thereof.

At 808, the AP 802 may transmit, to the STA 804, an indication of a threshold value associated with the selection between the spatial reuse communication mode or the multi-primary channel communication mode. In some aspects, the AP 802 may transmit the indication of the threshold value in association with receiving the information indicative of the capability of the STA 804 (such as in accordance with the STA 804 being capable of supporting the selection between the spatial reuse communication mode or the multi-primary channel communication mode). The AP 802 may transmit the indication of the threshold value, along with potentially other threshold values, via one or more of various frames. In some aspects, the AP 802 may transmit the indication of the threshold value via a broadcast management frame. Additionally, or alternatively, the AP 802 may transmit the indication of the threshold value via an association response frame or a reassociation response frame. Additionally, or alternatively, the AP 802 may transmit the indication of the threshold value via an A-Control field of a management or data frame or via an action frame.

In some aspects, the threshold value may be associated with (such as equal to an SINR at which a first data rate associated with the spatial reuse communication mode is greater than a second data rate associated with the multi-primary channel communication mode. Such use of the threshold value as being such an SINR may be associated with implementations in which the threshold value is used in relative terms (such as compared to RSSI-OBSS_RSSI). In some other aspects, the threshold value may be associated with (such as equal to) an interference level at which the spatial reuse communication mode is to be used instead of the multi-primary channel communication mode. Such use of the threshold value as being such an interference level may be associated with implementations in which the threshold value is directly compared to an OBSS_RSSI.

At 810-a and/or 810-b, the AP 802 and/or the STA 804 may perform one or more signal strength measurements. In some aspects, such signal strength measurements may include at least an OBSS_RSSI measurement. In some aspects, such signal strength measurements may further include at least one in-BSS_RSSI measurement. Such an in-BSS_RSSI measurement may be associated with a signal strength measurement of a packet (such as a most recently received packet) from a wireless communication device with which the AP 802 and/or the STA 804 expect to communicate. Additionally, or alternatively, the in-BSS_RSSI measurement may be associated with a signal strength measurement of a beacon frame (such as a most recently received beacon frame), such as a beacon frame transmitted by the AP 802.

At 812-a and/or 812-b, the AP 802 and/or the STA 804 may select the spatial reuse communication mode or the multi-primary channel communication mode in accordance with the signal strength measurement(s) and with the threshold value. For example, the AP 802 and/or the STA 804 may select one of the spatial reuse communication mode or the multi-primary channel communication mode depending on whether the threshold value is satisfied in accordance with the signal strength measurement(s). In some aspects, such a satisfaction of the threshold value may be associated with whether an OBSS_RSSI is greater than, equal to, or less than the threshold value. In some other aspects, such a satisfaction of the threshold value may be associated with whether a difference between an in-BSS_RSSI and an OBSS_RSSI (such as in-BSS_RSSI-OBSS_RSSI) is greater than, equal to, or less than the threshold value.

At 814, the AP 802 and the STA 804 may communicate using the selected one of the spatial reuse communication mode or the multi-primary channel communication mode. In some aspects, the AP 802 and the STA 804 may communicate using the spatial reuse communication mode in accordance with a satisfaction of the threshold value. In some other aspects, the AP 802 and the STA 804 may communicate using the multi-primary channel communication mode in accordance with a failure to satisfy the threshold value. Communication in accordance with the spatial reuse communication mode may include transmission and/or reception of one or more frames in accordance with an attempt to perform spatial reuse (such that spatial reuse may be performed or such that transmission and/or reception of the one or more frames may be deferred until after, for example, an OBSS transmission, depending on one or more spatial reuse conditions or criteria). Communication in accordance with the multi-primary channel communication mode may include transmission and/or reception of one or more frames in accordance with switching to an O-Primary subchannel in examples in which an OBSS detection is present on an M-Primary subchannel.

At 816, the AP 802 may transmit, to the STA 804, an indication of an updated threshold value associated with the selection between the spatial reuse communication mode or the multi-primary channel communication mode. The AP 802 may update the threshold value semi-statically or dynamically via one or more of various frame types, such as one or more management frames, action frames, data frames, or any combination thereof.

At 818-a and/or 818-b, the AP 802 and/or the STA 804 may update the threshold value associated with the selection between the spatial reuse communication mode or the multi-primary channel communication mode. In some implementations, the AP 802 and/or the STA 804 may update the threshold value by increasing or decreasing the threshold value by a delta value, which may be a static (such as fixed) value or a value that changes over time. In some implementations, the AP 802 and/or the STA 804 may update the threshold value in accordance with a failure to satisfy a criteria associated with a reception of a frame during the course of selection between the spatial reuse communication mode or the multi-primary channel communication mode, which may be indicative of asymmetric OBSS interference between a transmitter device and a receiver device (or some other reason for a lack of synchronization between a transmitter device and a receiver device).

At 820, the AP 802 and the STA 804 may (re-)select one of the spatial reuse communication mode or the multi-primary channel communication mode in accordance with the updated threshold value and communicate using the selected one of the spatial reuse communication mode or the multi-primary channel communication mode. In some aspects, the AP 802 and the STA 804 may communicate using the spatial reuse communication mode in accordance with a satisfaction of the updated threshold value. In some other aspects, the AP 802 and the STA 804 may communicate using the multi-primary channel communication mode in accordance with a failure to satisfy the updated threshold value. Communication in accordance with the spatial reuse communication mode may include transmission and/or reception of one or more frames in accordance with an attempt to perform spatial reuse (such that spatial reuse may be performed or such that transmission and/or reception of the one or more frames may be deferred until after, for example, an OBSS transmission depending on one or more spatial reuse conditions or criteria). Communication in accordance with the multi-primary channel communication mode may include transmission and/or reception of one or more frames in accordance with switching to an O-Primary subchannel in examples in which an OBSS detection is present on an M-Primary subchannel.

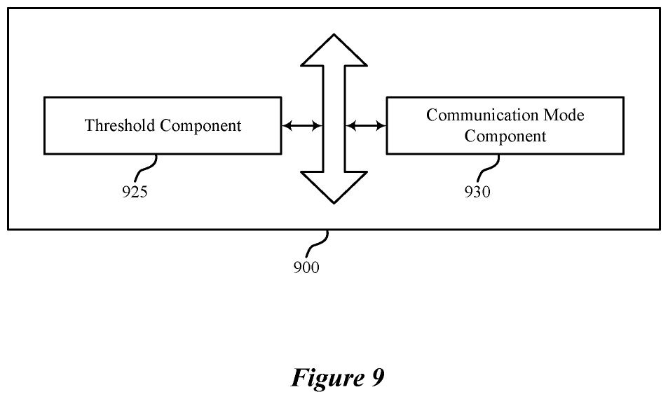

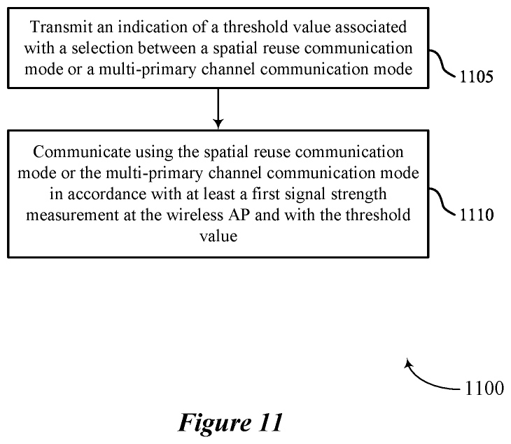

FIG. 9 shows a block diagram of an example wireless communication device 900 that supports signal strength-based selection between spatial reuse or multi-primary channel communication modes. In some examples, the wireless communication device 900 is configured to perform the processes 1100, 1200, and 1300 described with reference to FIGS. 11, 12, and 13, respectively. The wireless communication device 900 may include one or more chips, SoCs, chipsets, packages, components or devices that individually or collectively constitute or include a processing system. The processing system may interface with other components of the wireless communication device 900, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the wireless communication device 900 may transmit the information output from the chip. In such an example, the second interface may refer to an interface between the processing system of the chip and a reception component, such that the wireless communication device 900 may receive information that is passed to the processing system. In some such examples, the first interface also may obtain information, such as from the transmission component, and the second interface also may output information, such as to the reception component.

The processing system of the wireless communication device 900 includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or ROM, or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally, or alternatively, in some examples, one or more of the processors may be preconfigured to perform various functions or operations described herein without requiring configuration by software. The processing system may further include or be coupled with one or more modems (such as a Wi-Fi (such as IEEE compliant) modem or a cellular (such as 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 900 can be configurable or configured for use in an AP, such as the AP 102 described with reference to FIG. 1. In some other examples, the wireless communication device 900 can be an AP that includes such a processing system and other components including multiple antennas. The wireless communication device 900 is capable of transmitting and receiving wireless communication in the form of, for example, wireless packets. For example, the wireless communication device 900 can be configurable or configured to transmit and receive packets in the form of physical layer PPDUs and MPDUs conforming to one or more of the IEEE 802.11 family of wireless communication protocol standards. In some other examples, the wireless communication device 900 can be configurable or configured to transmit and receive signals and communication conforming to one or more 3GPP specifications including those for 5G NR or 6G. In some examples, the wireless communication device 900 also includes or can be coupled with one or more application processors which may be further coupled with one or more other memories. In some examples, the wireless communication device 900 further includes at least one external network interface coupled with the processing system that enables communication with a core network or backhaul network that enables the wireless communication device 900 to gain access to external networks including the Internet.

The wireless communication device 900 includes a threshold component 925 and a communication mode component 930. Portions of one or more of the threshold component 925 and the communication mode component 930 may be implemented at least in part in hardware or firmware. For example, one or more of the threshold component 925 and the communication mode component 930 may be implemented at least in part by at least a processor or a modem. In some examples, portions of one or more of the threshold component 925 and the communication mode component 930 may be implemented at least in part by a processor and software in the form of processor-executable code stored in memory.

The wireless communication device 900 may support wireless communication in accordance with examples as disclosed herein. The threshold component 925 is configurable or configured to transmit an indication of a threshold value associated with a selection between a spatial reuse communication mode or a multi-primary channel communication mode. The communication mode component 930 is configurable or configured to communicate using the spatial reuse communication mode or the multi-primary channel communication mode in accordance with at least a first signal strength measurement at the wireless AP and with the threshold value.

In some examples, to support communicating using the spatial reuse communication mode or the multi-primary channel communication mode, the communication mode component 930 is configurable or configured to communicate using the spatial reuse communication mode in accordance with a satisfaction of the threshold value, the satisfaction of the threshold value associated with at least the first signal strength measurement. In some examples, to support communicating using the spatial reuse communication mode or the multi-primary channel communication mode, the communication mode component 930 is configurable or configured to communicate using the multi-primary channel communication mode in accordance with a failure to satisfy the threshold value, the failure to satisfy the threshold value associated with at least the first signal strength measurement.

In some examples, the satisfaction of the threshold value is in accordance with a difference between the first signal strength measurement and a second signal strength measurement at the wireless AP being greater than or equal to the threshold value. In some examples, the failure to satisfy the threshold value is in accordance with the difference between the first signal strength measurement and the second signal strength measurement being less than the threshold value.

In some examples, the first signal strength measurement is an OBSS RSSI and the second signal strength measurement is an RSSI of a packet received from a wireless communication device with which the wireless AP expects to communicate using the spatial reuse communication mode or the multi-primary channel communication mode.

In some examples, the satisfaction of the threshold value is in accordance with the first signal strength measurement being less than or equal to the threshold value. In some examples, the failure to satisfy the threshold value is in accordance with the first signal strength measurement being greater than the threshold value.

In some examples, the threshold component 925 is configurable or configured to transmit an indication of an updated threshold value associated with the selection between the spatial reuse communication mode or the multi-primary channel communication mode. In some examples, the communication mode component 930 is configurable or configured to communicate using the spatial reuse communication mode or the multi-primary channel communication mode in accordance with the updated threshold value.

In some examples, the threshold component 925 is configurable or configured to transmit an indication of a set of multiple threshold values associated with the selection between the spatial reuse communication mode or the multi-primary channel communication mode, where each respective threshold value of the set of multiple threshold values is indicated for at least one wireless communication device of a set of multiple wireless communication devices associated with the wireless AP, and where the set of multiple threshold values includes the threshold value.

In some examples, a first threshold value of the set of multiple threshold values is indicated for a first wireless communication device of the set of multiple wireless communication devices and a second threshold value of the set of multiple threshold values is indicated for a second wireless communication device of the set of multiple wireless communication devices, the first threshold value different than or the same as the second threshold value.

In some examples, the communication mode component 930 is configurable or configured to transmit, using the spatial reuse communication mode or the multi-primary channel communication mode in accordance with at least the first signal strength measurement and with the threshold value, a first frame including a receiver address indicative of a wireless communication device. In some examples, the threshold component 925 is configurable or configured to update the threshold value by a delta value to a second threshold value in accordance with a failure to satisfy a criteria associated with reception, from the wireless communication device, of a second frame associated with the first frame. In some examples, the communication mode component 930 is configurable or configured to communicate with the wireless communication device using the spatial reuse communication mode or the multi-primary channel communication mode in accordance with the second threshold value.

In some examples, the communication mode component 930 is configurable or configured to transmit the first frame using the spatial reuse communication mode in accordance with a satisfaction of the threshold value, the satisfaction of the threshold value associated with at least the first signal strength measurement. In some examples, the threshold component 925 is configurable or configured to update the threshold value by the delta value to obtain the second threshold value in association with transmitting the first frame using the spatial reuse communication mode and the failure to satisfy the criteria associated with the reception of the second frame.

In some examples, to support updating the threshold value by the delta value to obtain the second threshold value, the threshold component 925 is configurable or configured to increase the threshold value by the delta value in accordance with the satisfaction of the threshold value being associated with a difference between the first signal strength measurement and a second signal strength measurement at the wireless AP being greater than or equal to the threshold value. In some examples, to support updating the threshold value by the delta value to obtain the second threshold value, the threshold component 925 is configurable or configured to decrease the threshold value by the delta value in accordance with the satisfaction of the threshold value being associated with the first signal strength measurement being less than or equal to the threshold value.

In some examples, the communication mode component 930 is configurable or configured to transmit the first frame using the multi-primary channel communication mode in accordance with a failure to satisfy the threshold value, the failure to satisfy the threshold value associated with at least the first signal strength measurement. In some examples, the threshold component 925 is configurable or configured to update the threshold value by the delta value to obtain the second threshold value in association with transmitting the first frame using the multi-primary channel communication mode and the failure to satisfy the criteria associated with the reception of the second frame.

In some examples, to support updating the threshold value by the delta value to obtain the second threshold value, the threshold component 925 is configurable or configured to decrease the threshold value by the delta value in accordance with the failure to satisfy the threshold value being associated with a difference between the first signal strength measurement and a second signal strength measurement at the wireless AP being less than the threshold value. In some examples, to support updating the threshold value by the delta value to obtain the second threshold value, the threshold component 925 is configurable or configured to increase the threshold value by the delta value in accordance with the failure to satisfy the threshold value being associated with the first signal strength measurement being greater than the threshold value.

In some examples, the delta value is a static value.

In some examples, the delta value increases in accordance with each failure to satisfy the criteria associated with the reception of the second frame.

In some examples, the threshold component 925 is configurable or configured to maintain a respective threshold value for each wireless communication device associated with the wireless AP on a per-overlapping basic service set (OBSS) basis.

In some examples, the communication mode component 930 is configurable or configured to transmit, to a first wireless communication device, using the spatial reuse communication mode or the multi-primary channel communication mode in accordance with at least the first signal strength measurement and with the threshold value, where the threshold value is maintained for interference from a first OBSS associated with the first signal strength measurement and communication with the first wireless communication device. In some examples, the communication mode component 930 is configurable or configured to transmit, to a second wireless communication device, using the spatial reuse communication mode or the multi-primary channel communication mode in accordance with at least a second signal strength measurement and a second threshold value, where the second threshold value is maintained for interference from a second OBSS associated with the second signal strength measurement and communication with the second wireless communication device.

In some examples, a first threshold value is maintained for communication with a first wireless communication device and interference from a first OBSS and a second threshold value is maintained for communication with the first wireless communication device and interference from a second OBSS.

In some examples, a first threshold value is maintained for communication with a first wireless communication device and interference from a first OBSS and a second threshold value is maintained for communication with a second wireless communication device and interference from the first OBSS.

In some examples, the threshold component 925 is configurable or configured to transmit the indication of the threshold value via a broadcast management frame.

In some examples, the threshold component 925 is configurable or configured to transmit the indication of the threshold value via an association response frame or a reassociation response frame.

In some examples, the threshold component 925 is configurable or configured to transmit the indication of the threshold value via an aggregated control (A-Control) field of a management or data frame or via an action frame.

In some examples, the communication mode component 930 is configurable or configured to receive, from a wireless communication device associated with the wireless AP, information indicative of a capability of the wireless communication device to support the selection between the spatial reuse communication mode or the multi-primary channel communication mode, where the indication of the threshold value is transmitted to the wireless communication device in association with receiving the information indicative of the capability of the wireless communication device.

In some examples, the threshold value is equal to an SINR at which a first data rate associated with the spatial reuse communication mode is greater than a second data rate associated with the multi-primary channel communication mode.

In some examples, the threshold value is equal to an interference level at which the spatial reuse communication mode is to be used instead of the multi-primary channel communication mode.

In some examples, the first signal strength measurement is an OBSS RSSI.

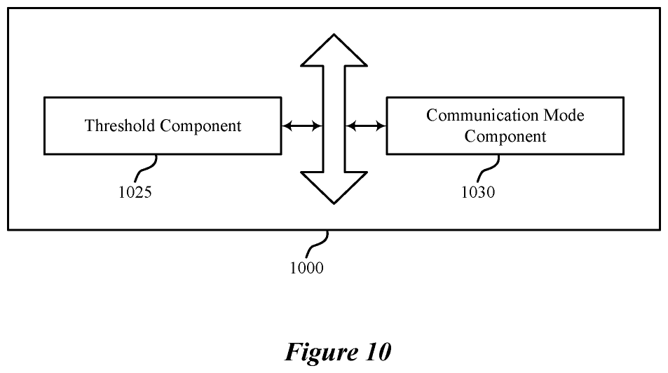

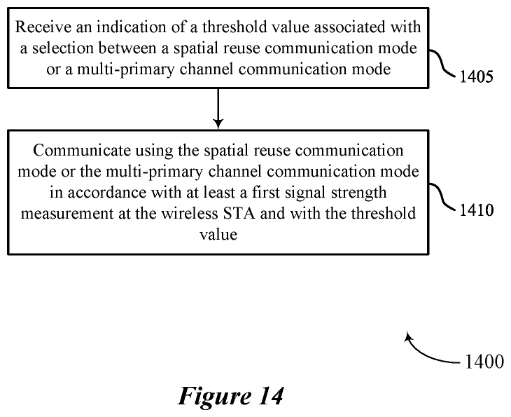

FIG. 10 shows a block diagram of an example wireless communication device 1000 that supports signal strength-based selection between spatial reuse or multi-primary channel communication modes. In some examples, the wireless communication device 1000 is configured to perform the processes 1400, 1500, and 1600 described with reference to FIGS. 14, 15, and 16, respectively. The wireless communication device 1000 may include one or more chips, SoCs, chipsets, packages, components or devices that individually or collectively constitute or include a processing system. The processing system may interface with other components of the wireless communication device 1000, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the wireless communication device 1000 may transmit the information output from the chip. In such an example, the second interface may refer to an interface between the processing system of the chip and a reception component, such that the wireless communication device 1000 may receive information that is passed to the processing system. In some such examples, the first interface also may obtain information, such as from the transmission component, and the second interface also may output information, such as to the reception component.

The processing system of the wireless communication device 1000 includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or ROM, or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally, or alternatively, in some examples, one or more of the processors may be preconfigured to perform various functions or operations described herein without requiring configuration by software. The processing system may further include or be coupled with one or more modems (such as a Wi-Fi (such as IEEE compliant) modem or a cellular (such as 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 1000 can be configurable or configured for use in a STA, such as the STA 104 described with reference to FIG. 1. In some other examples, the wireless communication device 1000 can be a STA that includes such a processing system and other components including multiple antennas. The wireless communication device 1000 is capable of transmitting and receiving wireless communication in the form of, for example, wireless packets. For example, the wireless communication device 1000 can be configurable or configured to transmit and receive packets in the form of physical layer PPDUs and MPDUs conforming to one or more of the IEEE 802.11 family of wireless communication protocol standards. In some other examples, the wireless communication device 1000 can be configurable or configured to transmit and receive signals and communication conforming to one or more 3GPP specifications including those for 5G NR or 6G. In some examples, the wireless communication device 1000 also includes or can be coupled with one or more application processors which may be further coupled with one or more other memories. In some examples, the wireless communication device 1000 further includes a user interface (UI) (such as a touchscreen or keypad) and a display, which may be integrated with the UI to form a touchscreen display that is coupled with the processing system. In some examples, the wireless communication device 1000 may further include one or more sensors such as, for example, one or more inertial sensors, accelerometers, temperature sensors, pressure sensors, or altitude sensors, that are coupled with the processing system.

The wireless communication device 1000 includes a threshold component 1025 and a communication mode component 1030. Portions of one or more of the threshold component 1025 and the communication mode component 1030 may be implemented at least in part in hardware or firmware. For example, one or more of the threshold component 1025 and the communication mode component 1030 may be implemented at least in part by at least a processor or a modem. In some examples, portions of one or more of the threshold component 1025 and the communication mode component 1030 may be implemented at least in part by a processor and software in the form of processor-executable code stored in memory.

The wireless communication device 1000 may support wireless communication in accordance with examples as disclosed herein. The threshold component 1025 is configurable or configured to receive an indication of a threshold value associated with a selection between a spatial reuse communication mode or a multi-primary channel communication mode. The communication mode component 1030 is configurable or configured to communicate using the spatial reuse communication mode or the multi-primary channel communication mode in accordance with at least a first signal strength measurement at the wireless STA and with the threshold value.

In some examples, to support communicating using the spatial reuse communication mode or the multi-primary channel communication mode, the communication mode component 1030 is configurable or configured to communicate using the spatial reuse communication mode in accordance with a satisfaction of the threshold value, the satisfaction of the threshold value associated with at least the first signal strength measurement. In some examples, to support communicating using the spatial reuse communication mode or the multi-primary channel communication mode, the communication mode component 1030 is configurable or configured to communicate using the multi-primary channel communication mode in accordance with a failure to satisfy the threshold value, the failure to satisfy the threshold value associated with at least the first signal strength measurement.

In some examples, the satisfaction of the threshold value is in accordance with a difference between the first signal strength measurement and a second signal strength measurement at the wireless STA being greater than or equal to the threshold value. In some examples, the failure to satisfy the threshold value is in accordance with the difference between the first signal strength measurement and the second signal strength measurement being less than the threshold value.

In some examples, the first signal strength measurement is an OBSS RSSI and the second signal strength measurement is an RSSI of a packet received from a wireless communication device with which the wireless STA expects to communicate using the spatial reuse communication mode or the multi-primary channel communication mode.

In some examples, the satisfaction of the threshold value is in accordance with the first signal strength measurement being less than or equal to the threshold value. In some examples, the failure to satisfy the threshold value is in accordance with the first signal strength measurement being greater than the threshold value.

In some examples, the threshold component 1025 is configurable or configured to receive an indication of an updated threshold value associated with the selection between the spatial reuse communication mode or the multi-primary channel communication mode. In some examples, the communication mode component 1030 is configurable or configured to communicate using the spatial reuse communication mode or the multi-primary channel communication mode in accordance with the updated threshold value.

In some examples, the communication mode component 1030 is configurable or configured to transmit, using the spatial reuse communication mode or the multi-primary channel communication mode in accordance with at least the first signal strength measurement and with the threshold value, a first frame including a receiver address indicative of a wireless communication device. In some examples, the threshold component 1025 is configurable or configured to update the threshold value by a delta value to a second threshold value in accordance with a failure to satisfy a criteria associated with reception, from the wireless communication device, of a second frame associated with the first frame. In some examples, the communication mode component 1030 is configurable or configured to communicate with the wireless communication device using the spatial reuse communication mode or the multi-primary channel communication mode in accordance with the second threshold value.

In some examples, the communication mode component 1030 is configurable or configured to transmit the first frame using the spatial reuse communication mode in accordance with a satisfaction of the threshold value, the satisfaction of the threshold value associated with at least the first signal strength measurement. In some examples, the threshold component 1025 is configurable or configured to update the threshold value by the delta value to obtain the second threshold value in association with transmitting the first frame using the spatial reuse communication mode and the failure to satisfy the criteria associated with the reception of the second frame.

In some examples, to support updating the threshold value by the delta value to obtain the second threshold value, the threshold component 1025 is configurable or configured to increase the threshold value by the delta value in accordance with the satisfaction of the threshold value being associated with a difference between the first signal strength measurement and a second signal strength measurement at the wireless STA being greater than or equal to the threshold value. In some examples, to support updating the threshold value by the delta value to obtain the second threshold value, the threshold component 1025 is configurable or configured to decrease the threshold value by the delta value in accordance with the satisfaction of the threshold value being associated with the first signal strength measurement being less than or equal to the threshold value.

In some examples, the communication mode component 1030 is configurable or configured to transmit the first frame using the multi-primary channel communication mode in accordance with a failure to satisfy the threshold value, the failure to satisfy the threshold value associated with at least the first signal strength measurement. In some examples, the threshold component 1025 is configurable or configured to update the threshold value by the delta value to obtain the second threshold value in association with transmitting the first frame using the multi-primary channel communication mode and the failure to satisfy the criteria associated with the reception of the second frame.

In some examples, to support updating the threshold value by the delta value to obtain the second threshold value, the threshold component 1025 is configurable or configured to decrease the threshold value by the delta value in accordance with the failure to satisfy the threshold value being associated with a difference between the first signal strength measurement and a second signal strength measurement at the wireless STA being less than the threshold value. In some examples, to support updating the threshold value by the delta value to obtain the second threshold value, the threshold component 1025 is configurable or configured to increase the threshold value by the delta value in accordance with the failure to satisfy the threshold value being associated with the first signal strength measurement being greater than the threshold value.

In some examples, the delta value is a static value.

In some examples, the delta value increases in accordance with each failure to satisfy the criteria associated with the reception of the second frame.

In some examples, the threshold component 1025 is configurable or configured to maintain a respective threshold value for each wireless communication device associated with the wireless STA on a per-overlapping basic service set (OBSS) basis.

In some examples, the communication mode component 1030 is configurable or configured to transmit, to a first wireless communication device, using the spatial reuse communication mode or the multi-primary channel communication mode in accordance with at least the first signal strength measurement and with the threshold value, where the threshold value is maintained for interference from a first OBSS associated with the first signal strength measurement and communication with the first wireless communication device. In some examples, the communication mode component 1030 is configurable or configured to transmit, to a second wireless communication device, using the spatial reuse communication mode or the multi-primary channel communication mode in accordance with at least a second signal strength measurement and a second threshold value, where the second threshold value is maintained for interference from a second OBSS associated with the second signal strength measurement and communication with the second wireless communication device.

In some examples, a first threshold value is maintained for communication with a first wireless communication device and interference from a first OBSS and a second threshold value is maintained for communication with the first wireless communication device and interference from a second OBSS.

In some examples, a first threshold value is maintained for communication with a first wireless communication device and interference from a first OBSS and a second threshold value is maintained for communication with a second wireless communication device and interference from the first OBSS.

In some examples, the threshold component 1025 is configurable or configured to receive the indication of the threshold value via a broadcast management frame.

In some examples, the threshold component 1025 is configurable or configured to receive the indication of the threshold value via an association response frame or a reassociation response frame.

In some examples, the threshold component 1025 is configurable or configured to receive the indication of the threshold value via an aggregated control (A-Control) field of a management or data frame or via an action frame.

In some examples, the communication mode component 1030 is configurable or configured to transmit, to a wireless AP, information indicative of a capability of the wireless STA to support the selection between the spatial reuse communication mode or the multi-primary channel communication mode, where the indication of the threshold value is received from the wireless AP in association with transmitting the information indicative of the capability of the wireless STA.

In some examples, the threshold value is equal to an SINR at which a first data rate associated with the spatial reuse communication mode is greater than a second data rate associated with the multi-primary channel communication mode.

In some examples, the threshold value is equal to an interference level at which the spatial reuse communication mode is to be used instead of the multi-primary channel communication mode.

In some examples, the first signal strength measurement is an OBSS RSSI.

FIG. 11 shows a flowchart illustrating an example process 1100 performable by or at a wireless AP that supports signal strength-based selection between spatial reuse or multi-primary channel communication modes. The operations of the process 1100 may be implemented by a wireless AP or its components as described herein. For example, the process 1100 may be performed by a wireless communication device, such as the wireless communication device 900 described with reference to FIG. 9, operating as or within a wireless AP. In some examples, the process 1100 may be performed by a wireless AP, such as one of the APs 102 described with reference to FIG. 1.

In some examples, in 1105, the wireless AP may transmit an indication of a threshold value associated with a selection between a spatial reuse communication mode or a multi-primary channel communication mode. The operations of 1105 may be performed in accordance with examples as disclosed herein. In some implementations, aspects of the operations of 1105 may be performed by a threshold component 925 as described with reference to FIG. 9.

In some examples, in 1110, the wireless AP may communicate using the spatial reuse communication mode or the multi-primary channel communication mode in accordance with at least a first signal strength measurement at the wireless AP and with the threshold value. The operations of 1110 may be performed in accordance with examples as disclosed herein. In some implementations, aspects of the operations of 1110 may be performed by a communication mode component 930 as described with reference to FIG. 9.

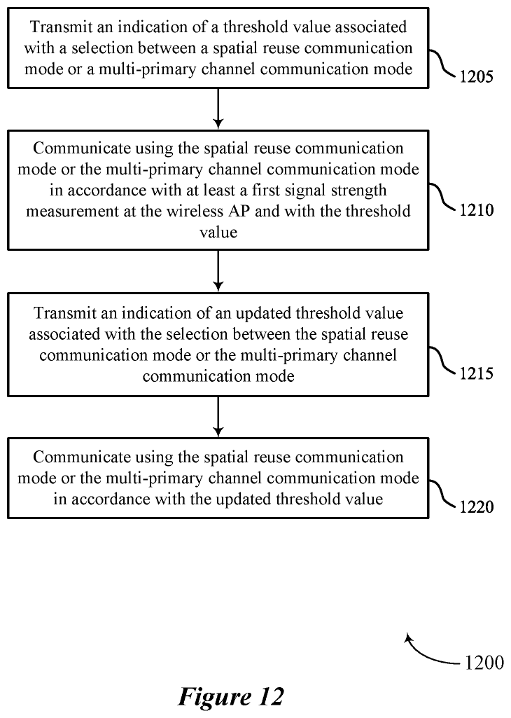

FIG. 12 shows a flowchart illustrating an example process 1200 performable by or at a wireless AP that supports signal strength-based selection between spatial reuse or multi-primary channel communication modes. The operations of the process 1200 may be implemented by a wireless AP or its components as described herein. For example, the process 1200 may be performed by a wireless communication device, such as the wireless communication device 900 described with reference to FIG. 9, operating as or within a wireless AP. In some examples, the process 1200 may be performed by a wireless AP, such as one of the APs 102 described with reference to FIG. 1.

In some examples, in 1205, the wireless AP may transmit an indication of a threshold value associated with a selection between a spatial reuse communication mode or a multi-primary channel communication mode. The operations of 1205 may be performed in accordance with examples as disclosed herein. In some implementations, aspects of the operations of 1205 may be performed by a threshold component 925 as described with reference to FIG. 9.

In some examples, in 1210, the wireless AP may communicate using the spatial reuse communication mode or the multi-primary channel communication mode in accordance with at least a first signal strength measurement at the wireless AP and with the threshold value. The operations of 1210 may be performed in accordance with examples as disclosed herein. In some implementations, aspects of the operations of 1210 may be performed by a communication mode component 930 as described with reference to FIG. 9.

In some examples, in 1215, the wireless AP may transmit an indication of an updated threshold value associated with the selection between the spatial reuse communication mode or the multi-primary channel communication mode. The operations of 1215 may be performed in accordance with examples as disclosed herein. In some implementations, aspects of the operations of 1215 may be performed by a threshold component 925 as described with reference to FIG. 9.

In some examples, in 1220, the wireless AP may communicate using the spatial reuse communication mode or the multi-primary channel communication mode in accordance with the updated threshold value. The operations of 1220 may be performed in accordance with examples as disclosed herein. In some implementations, aspects of the operations of 1220 may be performed by a communication mode component 930 as described with reference to FIG. 9.

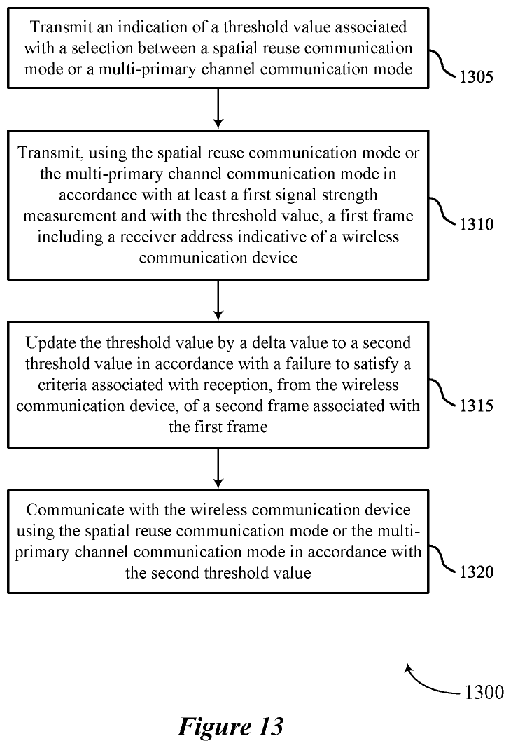

FIG. 13 shows a flowchart illustrating an example process 1300 performable by or at a wireless AP that supports signal strength-based selection between spatial reuse or multi-primary channel communication modes. The operations of the process 1300 may be implemented by a wireless AP or its components as described herein. For example, the process 1300 may be performed by a wireless communication device, such as the wireless communication device 900 described with reference to FIG. 9, operating as or within a wireless AP. In some examples, the process 1300 may be performed by a wireless AP, such as one of the APs 102 described with reference to FIG. 1.

In some examples, in 1305, the wireless AP may transmit an indication of a threshold value associated with a selection between a spatial reuse communication mode or a multi-primary channel communication mode. The operations of 1305 may be performed in accordance with examples as disclosed herein. In some implementations, aspects of the operations of 1305 may be performed by a threshold component 925 as described with reference to FIG. 9.

In some examples, in 1310, the wireless AP may transmit, using the spatial reuse communication mode or the multi-primary channel communication mode in accordance with at least a first signal strength measurement and with the threshold value, a first frame including a receiver address indicative of a wireless communication device. The operations of 1310 may be performed in accordance with examples as disclosed herein. In some implementations, aspects of the operations of 1310 may be performed by a communication mode component 930 as described with reference to FIG. 9.

In some examples, in 1315, the wireless AP may update the threshold value by a delta value to a second threshold value in accordance with a failure to satisfy a criteria associated with reception, from the wireless communication device, of a second frame associated with the first frame. The operations of 1315 may be performed in accordance with examples as disclosed herein. In some implementations, aspects of the operations of 1315 may be performed by a threshold component 925 as described with reference to FIG. 9.

In some examples, in 1320, the wireless AP may communicate with the wireless communication device using the spatial reuse communication mode or the multi-primary channel communication mode in accordance with the second threshold value. The operations of 1320 may be performed in accordance with examples as disclosed herein. In some implementations, aspects of the operations of 1320 may be performed by a communication mode component 930 as described with reference to FIG. 9.

FIG. 14 shows a flowchart illustrating an example process 1400 performable by or at a wireless STA that supports signal strength-based selection between spatial reuse or multi-primary channel communication modes. The operations of the process 1400 may be implemented by a wireless STA or its components as described herein. For example, the process 1400 may be performed by a wireless communication device, such as the wireless communication device 1000 described with reference to FIG. 10, operating as or within a wireless STA. In some examples, the process 1400 may be performed by a wireless STA, such as one of the STAs 104 described with reference to FIG. 1.

In some examples, in 1405, the wireless STA may receive an indication of a threshold value associated with a selection between a spatial reuse communication mode or a multi-primary channel communication mode. The operations of 1405 may be performed in accordance with examples as disclosed herein. In some implementations, aspects of the operations of 1405 may be performed by a threshold component 1025 as described with reference to FIG. 10.

In some examples, in 1410, the wireless STA may communicate using the spatial reuse communication mode or the multi-primary channel communication mode in accordance with at least a first signal strength measurement at the wireless STA and with the threshold value. The operations of 1410 may be performed in accordance with examples as disclosed herein. In some implementations, aspects of the operations of 1410 may be performed by a communication mode component 1030 as described with reference to FIG. 10.

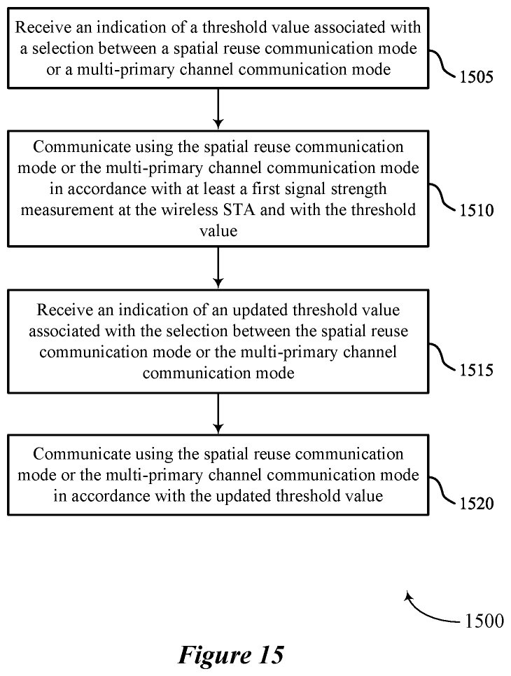

FIG. 15 shows a flowchart illustrating an example process 1500 performable by or at a wireless STA that supports signal strength-based selection between spatial reuse or multi-primary channel communication modes. The operations of the process 1500 may be implemented by a wireless STA or its components as described herein. For example, the process 1500 may be performed by a wireless communication device, such as the wireless communication device 1000 described with reference to FIG. 10, operating as or within a wireless STA. In some examples, the process 1500 may be performed by a wireless STA, such as one of the STAs 104 described with reference to FIG. 1.

In some examples, in 1505, the wireless STA may receive an indication of a threshold value associated with a selection between a spatial reuse communication mode or a multi-primary channel communication mode. The operations of 1505 may be performed in accordance with examples as disclosed herein. In some implementations, aspects of the operations of 1505 may be performed by a threshold component 1025 as described with reference to FIG. 10.

In some examples, in 1510, the wireless STA may communicate using the spatial reuse communication mode or the multi-primary channel communication mode in accordance with at least a first signal strength measurement at the wireless STA and with the threshold value. The operations of 1510 may be performed in accordance with examples as disclosed herein. In some implementations, aspects of the operations of 1510 may be performed by a communication mode component 1030 as described with reference to FIG. 10.

In some examples, in 1515, the wireless STA may receive an indication of an updated threshold value associated with the selection between the spatial reuse communication mode or the multi-primary channel communication mode. The operations of 1515 may be performed in accordance with examples as disclosed herein. In some implementations, aspects of the operations of 1515 may be performed by a threshold component 1025 as described with reference to FIG. 10.

In some examples, in 1520, the wireless STA may communicate using the spatial reuse communication mode or the multi-primary channel communication mode in accordance with the updated threshold value. The operations of 1520 may be performed in accordance with examples as disclosed herein. In some implementations, aspects of the operations of 1520 may be performed by a communication mode component 1030 as described with reference to FIG. 10.

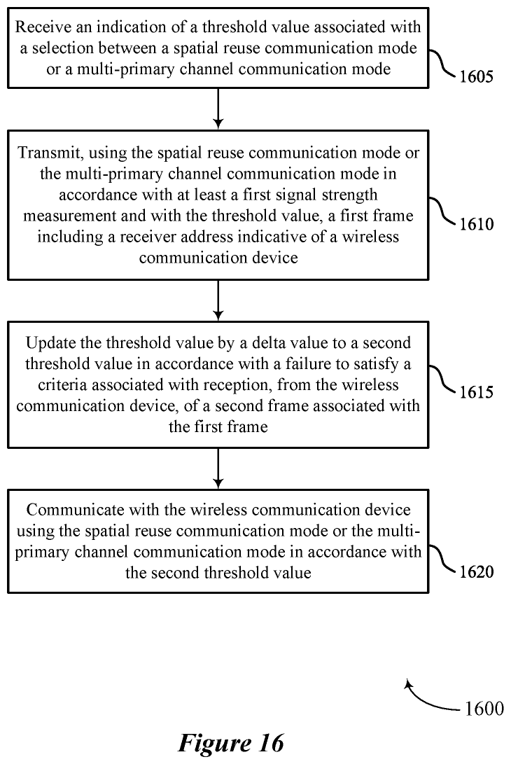

FIG. 16 shows a flowchart illustrating an example process 1600 performable by or at a wireless STA that supports signal strength-based selection between spatial reuse or multi-primary channel communication modes. The operations of the process 1600 may be implemented by a wireless STA or its components as described herein. For example, the process 1600 may be performed by a wireless communication device, such as the wireless communication device 1000 described with reference to FIG. 10, operating as or within a wireless STA. In some examples, the process 1600 may be performed by a wireless STA, such as one of the STAs 104 described with reference to FIG. 1.

In some examples, in 1605, the wireless STA may receive an indication of a threshold value associated with a selection between a spatial reuse communication mode or a multi-primary channel communication mode. The operations of 1605 may be performed in accordance with examples as disclosed herein. In some implementations, aspects of the operations of 1605 may be performed by a threshold component 1025 as described with reference to FIG. 10.

In some examples, in 1610, the wireless STA may transmit, using the spatial reuse communication mode or the multi-primary channel communication mode in accordance with at least a first signal strength measurement and with the threshold value, a first frame including a receiver address indicative of a wireless communication device. The operations of 1610 may be performed in accordance with examples as disclosed herein. In some implementations, aspects of the operations of 1610 may be performed by a communication mode component 1030 as described with reference to FIG. 10.

In some examples, in 1615, the wireless STA may update the threshold value by a delta value to a second threshold value in accordance with a failure to satisfy a criteria associated with reception, from the wireless communication device, of a second frame associated with the first frame. The operations of 1615 may be performed in accordance with examples as disclosed herein. In some implementations, aspects of the operations of 1615 may be performed by a threshold component 1025 as described with reference to FIG. 10.

In some examples, in 1620, the wireless STA may communicate with the wireless communication device using the spatial reuse communication mode or the multi-primary channel communication mode in accordance with the second threshold value. The operations of 1620 may be performed in accordance with examples as disclosed herein. In some implementations, aspects of the operations of 1620 may be performed by a communication mode component 1030 as described with reference to FIG. 10.

Implementation examples are described in the following numbered clauses:

Clause 1: A method for wireless communication by a wireless AP, including: transmitting an indication of a threshold value associated with a selection between a spatial reuse communication mode or a multi-primary channel communication mode; and communicating using the spatial reuse communication mode or the multi-primary channel communication mode in accordance with at least a first signal strength measurement at the wireless AP and with the threshold value.

Clause 2: The method of clause 1, where communicating using the spatial reuse communication mode or the multi-primary channel communication mode includes: communicating using the spatial reuse communication mode in accordance with a satisfaction of the threshold value, the satisfaction of the threshold value associated with at least the first signal strength measurement; or communicating using the multi-primary channel communication mode in accordance with a failure to satisfy the threshold value, the failure to satisfy the threshold value associated with at least the first signal strength measurement.

Clause 3: The method of clause 2, where the satisfaction of the threshold value is in accordance with a difference between the first signal strength measurement and a second signal strength measurement at the wireless AP being greater than or equal to the threshold value, and the failure to satisfy the threshold value is in accordance with the difference between the first signal strength measurement and the second signal strength measurement being less than the threshold value.

Clause 4: The method of clause 3, where the first signal strength measurement is an OBSS RSSI and the second signal strength measurement is an RSSI of a packet received from a wireless communication device with which the wireless AP expects to communicate using the spatial reuse communication mode or the multi-primary channel communication mode.

Clause 5: The method of any of clauses 2-4, where the satisfaction of the threshold value is in accordance with the first signal strength measurement being less than or equal to the threshold value, and the failure to satisfy the threshold value is in accordance with the first signal strength measurement being greater than the threshold value.

Clause 6: The method of any of clauses 1-5, further including: transmitting an indication of an updated threshold value associated with the selection between the spatial reuse communication mode or the multi-primary channel communication mode; and communicating using the spatial reuse communication mode or the multi-primary channel communication mode in accordance with the updated threshold value.

Clause 7: The method of any of clauses 1-6, further including: transmitting an indication of a plurality of threshold values associated with the selection between the spatial reuse communication mode or the multi-primary channel communication mode, where each respective threshold value of the plurality of threshold values is indicated for at least one wireless communication device of a plurality of wireless communication devices associated with the wireless AP, and where the plurality of threshold values includes the threshold value.

Clause 8: The method of clause 7, where a first threshold value of the plurality of threshold values is indicated for a first wireless communication device of the plurality of wireless communication devices and a second threshold value of the plurality of threshold values is indicated for a second wireless communication device of the plurality of wireless communication devices, the first threshold value different than or the same as the second threshold value.

Clause 9: The method of any of clauses 1-8, further including: transmitting, using the spatial reuse communication mode or the multi-primary channel communication mode in accordance with at least the first signal strength measurement and with the threshold value, a first frame including a receiver address indicative of a wireless communication device; updating the threshold value by a delta value to a second threshold value in accordance with a failure to satisfy a criteria associated with reception, from the wireless communication device, of a second frame associated with the first frame; and communicating with the wireless communication device using the spatial reuse communication mode or the multi-primary channel communication mode in accordance with the second threshold value.

Clause 10: The method of clause 9, further including: transmitting the first frame using the spatial reuse communication mode in accordance with a satisfaction of the threshold value, the satisfaction of the threshold value associated with at least the first signal strength measurement; and updating the threshold value by the delta value to obtain the second threshold value in association with transmitting the first frame using the spatial reuse communication mode and the failure to satisfy the criteria associated with the reception of the second frame.

Clause 11: The method of clause 10, where updating the threshold value by the delta value to obtain the second threshold value includes: increasing the threshold value by the delta value in accordance with the satisfaction of the threshold value being associated with a difference between the first signal strength measurement and a second signal strength measurement at the wireless AP being greater than or equal to the threshold value; or decreasing the threshold value by the delta value in accordance with the satisfaction of the threshold value being associated with the first signal strength measurement being less than or equal to the threshold value.

Clause 12: The method of clause 9, further including: transmitting the first frame using the multi-primary channel communication mode in accordance with a failure to satisfy the threshold value, the failure to satisfy the threshold value associated with at least the first signal strength measurement; and updating the threshold value by the delta value to obtain the second threshold value in association with transmitting the first frame using the multi-primary channel communication mode and the failure to satisfy the criteria associated with the reception of the second frame.

Clause 13: The method of clause 12, where updating the threshold value by the delta value to obtain the second threshold value includes: decreasing the threshold value by the delta value in accordance with the failure to satisfy the threshold value being associated with a difference between the first signal strength measurement and a second signal strength measurement at the wireless AP being less than the threshold value; or increasing the threshold value by the delta value in accordance with the failure to satisfy the threshold value being associated with the first signal strength measurement being greater than the threshold value.

Clause 14: The method of any of clauses 9-13, where the delta value is a static value.

Clause 15: The method of any of clauses 9-14, where the delta value increases in accordance with each failure to satisfy the criteria associated with the reception of the second frame.

Clause 16: The method of any of clauses 1-15, further including: maintaining a respective threshold value for each wireless communication device associated with the wireless AP on a per-OBSS basis.

Clause 17: The method of clause 16, further including: transmitting, to a first wireless communication device, using the spatial reuse communication mode or the multi-primary channel communication mode in accordance with at least the first signal strength measurement and with the threshold value, where the threshold value is maintained for interference from a first OBSS associated with the first signal strength measurement and communication with the first wireless communication device; and transmitting, to a second wireless communication device, using the spatial reuse communication mode or the multi-primary channel communication mode in accordance with at least a second signal strength measurement and a second threshold value, where the second threshold value is maintained for interference from a second OBSS associated with the second signal strength measurement and communication with the second wireless communication device.

Clause 18: The method of any of clauses 16-17, where a first threshold value is maintained for communication with a first wireless communication device and interference from a first OBSS and a second threshold value is maintained for communication with the first wireless communication device and interference from a second OBSS.

Clause 19: The method of any of clauses 16-18, where a first threshold value is maintained for communication with a first wireless communication device and interference from a first OBSS and a second threshold value is maintained for communication with a second wireless communication device and interference from the first OBSS.

Clause 20: The method of any of clauses 1-19, further including: transmitting the indication of the threshold value via a broadcast management frame.

Clause 21: The method of any of clauses 1-20, further including: transmitting the indication of the threshold value via an association response frame or a reassociation response frame.

Clause 22: The method of any of clauses 1-21, further including: transmitting the indication of the threshold value via an A-Control field of a management or data frame or via an action frame.

Clause 23: The method of any of clauses 1-22, further including: receiving, from a wireless communication device associated with the wireless AP, information indicative of a capability of the wireless communication device to support the selection between the spatial reuse communication mode or the multi-primary channel communication mode, where the indication of the threshold value is transmitted to the wireless communication device in association with receiving the information indicative of the capability of the wireless communication device.

Clause 24: The method of any of clauses 1-23, where the threshold value is equal to an SINR at which a first data rate associated with the spatial reuse communication mode is greater than a second data rate associated with the multi-primary channel communication mode.

Clause 25: The method of any of clauses 1-23, where the threshold value is equal to an interference level at which the spatial reuse communication mode is to be used instead of the multi-primary channel communication mode.

Clause 26: The method of any of clauses 1-25, where the first signal strength measurement is an OBSS RSSI.

Clause 27: A method for wireless communication at a wireless STA, including: receiving an indication of a threshold value associated with a selection between a spatial reuse communication mode or a multi-primary channel communication mode; and communicating using the spatial reuse communication mode or the multi-primary channel communication mode in accordance with at least a first signal strength measurement at the wireless STA and with the threshold value.

Clause 28: The method of clause 27, where communicating using the spatial reuse communication mode or the multi-primary channel communication mode includes: communicating using the spatial reuse communication mode in accordance with a satisfaction of the threshold value, the satisfaction of the threshold value associated with at least the first signal strength measurement; or communicating using the multi-primary channel communication mode in accordance with a failure to satisfy the threshold value, the failure to satisfy the threshold value associated with at least the first signal strength measurement.

Clause 29: The method of clause 28, where the satisfaction of the threshold value is in accordance with a difference between the first signal strength measurement and a second signal strength measurement at the wireless STA being greater than or equal to the threshold value, and the failure to satisfy the threshold value is in accordance with the difference between the first signal strength measurement and the second signal strength measurement being less than the threshold value.

Clause 30: The method of clause 29, where the first signal strength measurement is an OBSS RSSI and the second signal strength measurement is an RSSI of a packet received from a wireless communication device with which the wireless STA expects to communicate using the spatial reuse communication mode or the multi-primary channel communication mode.

Clause 31: The method of any of clauses 28-30, where the satisfaction of the threshold value is in accordance with the first signal strength measurement being less than or equal to the threshold value, and the failure to satisfy the threshold value is in accordance with the first signal strength measurement being greater than the threshold value.

Clause 32: The method of any of clauses 27-31, further including: receiving an indication of an updated threshold value associated with the selection between the spatial reuse communication mode or the multi-primary channel communication mode; and communicating using the spatial reuse communication mode or the multi-primary channel communication mode in accordance with the updated threshold value.

Clause 33: The method of any of clauses 27-32, further including: transmitting, using the spatial reuse communication mode or the multi-primary channel communication mode in accordance with at least the first signal strength measurement and with the threshold value, a first frame including a receiver address indicative of a wireless communication device; updating the threshold value by a delta value to a second threshold value in accordance with a failure to satisfy a criteria associated with reception, from the wireless communication device, of a second frame associated with the first frame; and communicating with the wireless communication device using the spatial reuse communication mode or the multi-primary channel communication mode in accordance with the second threshold value.

Clause 34: The method of clause 33, further including: transmitting the first frame using the spatial reuse communication mode in accordance with a satisfaction of the threshold value, the satisfaction of the threshold value associated with at least the first signal strength measurement; and updating the threshold value by the delta value to obtain the second threshold value in association with transmitting the first frame using the spatial reuse communication mode and the failure to satisfy the criteria associated with the reception of the second frame.

Clause 35: The method of clause 34, where updating the threshold value by the delta value to obtain the second threshold value includes: increasing the threshold value by the delta value in accordance with the satisfaction of the threshold value being associated with a difference between the first signal strength measurement and a second signal strength measurement at the wireless STA being greater than or equal to the threshold value; or decreasing the threshold value by the delta value in accordance with the satisfaction of the threshold value being associated with the first signal strength measurement being less than or equal to the threshold value.

Clause 36: The method of clause 33, further including: transmitting the first frame using the multi-primary channel communication mode in accordance with a failure to satisfy the threshold value, the failure to satisfy the threshold value associated with at least the first signal strength measurement; and updating the threshold value by the delta value to obtain the second threshold value in association with transmitting the first frame using the multi-primary channel communication mode and the failure to satisfy the criteria associated with the reception of the second frame.

Clause 37: The method of clause 36, where updating the threshold value by the delta value to obtain the second threshold value includes: decreasing the threshold value by the delta value in accordance with the failure to satisfy the threshold value being associated with a difference between the first signal strength measurement and a second signal strength measurement at the wireless STA being less than the threshold value; or increasing the threshold value by the delta value in accordance with the failure to satisfy the threshold value being associated with the first signal strength measurement being greater than the threshold value.

Clause 38: The method of any of clauses 33-37, where the delta value is a static value.

Clause 39: The method of any of clauses 33-38, where the delta value increases in accordance with each failure to satisfy the criteria associated with the reception of the second frame.

Clause 40: The method of any of clauses 27-39, further including: maintaining a respective threshold value for each wireless communication device associated with the wireless STA on a per-OBSS basis.

Clause 41: The method of clause 40, further including: transmitting, to a first wireless communication device, using the spatial reuse communication mode or the multi-primary channel communication mode in accordance with at least the first signal strength measurement and with the threshold value, where the threshold value is maintained for interference from a first OBSS associated with the first signal strength measurement and communication with the first wireless communication device; and transmitting, to a second wireless communication device, using the spatial reuse communication mode or the multi-primary channel communication mode in accordance with at least a second signal strength measurement and a second threshold value, where the second threshold value is maintained for interference from a second OBSS associated with the second signal strength measurement and communication with the second wireless communication device.

Clause 42: The method of any of clauses 40-41, where a first threshold value is maintained for communication with a first wireless communication device and interference from a first OBSS and a second threshold value is maintained for communication with the first wireless communication device and interference from a second OBSS.

Clause 43: The method of any of clauses 40-42, where a first threshold value is maintained for communication with a first wireless communication device and interference from a first OBSS and a second threshold value is maintained for communication with a second wireless communication device and interference from the first OBSS.

Clause 44: The method of any of clauses 27-43, further including: receiving the indication of the threshold value via a broadcast management frame.

Clause 45: The method of any of clauses 27-44, further including: receiving the indication of the threshold value via an association response frame or a reassociation response frame.

Clause 46: The method of any of clauses 27-45, further including: receiving the indication of the threshold value via an A-Control field of a management or data frame or via an action frame.

Clause 47: The method of any of clauses 27-46, further including: transmitting, to a wireless AP, information indicative of a capability of the wireless STA to support the selection between the spatial reuse communication mode or the multi-primary channel communication mode, where the indication of the threshold value is received from the wireless AP in association with transmitting the information indicative of the capability of the wireless STA.

Clause 48: The method of any of clauses 27-47, where the threshold value is equal to an SINR at which a first data rate associated with the spatial reuse communication mode is greater than a second data rate associated with the multi-primary channel communication mode.

Clause 49: The method of any of clauses 27-47, where the threshold value is equal to an interference level at which the spatial reuse communication mode is to be used instead of the multi-primary channel communication mode.

Clause 50: The method of any of clauses 27-49, where the first signal strength measurement is an OBSS RSSI.

Clause 51: A wireless AP, including a processing system that includes processor circuitry and memory circuitry that stores code, the processing system configured to cause the wireless AP to perform a method of any of clauses 1-26.

Clause 52: A wireless AP, including one or more memories storing processor-executable code, and one or more processors coupled with the one or more memories and individually or collectively operable to execute the code to cause the wireless AP to perform a method of any of clauses 1-26.

Clause 53: A wireless AP, including at least one means for performing a method of any of clauses 1-26.

Clause 54: A non-transitory computer-readable medium storing code for wireless communication, the code including instructions executable by a processing system (such as one or more processors) to perform a method of any of clauses 1-26.

Clause 55: A wireless STA, including a processing system that includes processor circuitry and memory circuitry that stores code, the processing system configured to cause the wireless STA to perform a method of any of clauses 27-50.

Clause 56: A wireless STA, including one or more memories storing processor-executable code, and one or more processors coupled with the one or more memories and individually or collectively operable to execute the code to cause the wireless STA to perform a method of any of clauses 27-50.

Clause 57: A wireless STA, including at least one means for performing a method of any of clauses 27-50.

Clause 58: A non-transitory computer-readable medium storing code for wireless communication, the code including instructions executable by a processing system (such as one or more processors) to perform a method of any of clauses 27-50.

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing and other such similar actions.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset” refers to less than a whole set, but non-empty.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions, or information.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

What is claimed is:

1. A wireless access point (AP), comprising:
a processing system that includes processor circuitry and memory circuitry that stores code, the processing system configured to cause the wireless AP to:
transmit an indication of a threshold value associated with a selection between a spatial reuse communication mode or a multi-primary channel communication mode; and
communicate using the spatial reuse communication mode or the multi-primary channel communication mode in accordance with at least a first signal strength measurement at the wireless AP and with the threshold value.

2. The wireless AP of claim 1, wherein, to communicate using the spatial reuse communication mode or the multi-primary channel communication mode, the processing system is configured to cause the wireless AP to:
communicate using the spatial reuse communication mode in accordance with a satisfaction of the threshold value, the satisfaction of the threshold value associated with at least the first signal strength measurement; or
communicate using the multi-primary channel communication mode in accordance with a failure to satisfy the threshold value, the failure to satisfy the threshold value associated with at least the first signal strength measurement.

3. The wireless AP of claim 2, wherein:
the satisfaction of the threshold value is in accordance with a difference between the first signal strength measurement and a second signal strength measurement at the wireless AP being greater than or equal to the threshold value; and
the failure to satisfy the threshold value is in accordance with the difference between the first signal strength measurement and the second signal strength measurement being less than the threshold value.

4. The wireless AP of claim 3, wherein the first signal strength measurement is an overlapping basic service set (OBSS) received signal strength indicator (RSSI) and the second signal strength measurement is an RSSI of a packet received from a wireless communication device with which the wireless AP expects to communicate using the spatial reuse communication mode or the multi-primary channel communication mode.

5. The wireless AP of claim 2, wherein:
the satisfaction of the threshold value is in accordance with the first signal strength measurement being less than or equal to the threshold value; and
the failure to satisfy the threshold value is in accordance with the first signal strength measurement being greater than the threshold value.

6. The wireless AP of claim 1, wherein the processing system is further configured to cause the wireless AP to:
transmit an indication of an updated threshold value associated with the selection between the spatial reuse communication mode or the multi-primary channel communication mode; and
communicate using the spatial reuse communication mode or the multi-primary channel communication mode in accordance with the updated threshold value.

7. The wireless AP of claim 1, wherein the processing system is further configured to cause the wireless AP to:
transmit an indication of a plurality of threshold values associated with the selection between the spatial reuse communication mode or the multi-primary channel communication mode, wherein each respective threshold value of the plurality of threshold values is indicated for at least one wireless communication device of a plurality of wireless communication devices associated with the wireless AP, and wherein the plurality of threshold values includes the threshold value.

8. The wireless AP of claim 7, wherein a first threshold value of the plurality of threshold values is indicated for a first wireless communication device of the plurality of wireless communication devices and a second threshold value of the plurality of threshold values is indicated for a second wireless communication device of the plurality of wireless communication devices, the first threshold value different than or the same as the second threshold value.

9. The wireless AP of claim 1, wherein the processing system is further configured to cause the wireless AP to:
transmit, using the spatial reuse communication mode or the multi-primary channel communication mode in accordance with at least the first signal strength measurement and with the threshold value, a first frame including a receiver address indicative of a wireless communication device;
update the threshold value by a delta value to a second threshold value in accordance with a failure to satisfy a criteria associated with reception, from the wireless communication device, of a second frame associated with the first frame; and
communicate with the wireless communication device using the spatial reuse communication mode or the multi-primary channel communication mode in accordance with the second threshold value.

10. The wireless AP of claim 9, wherein the processing system is further configured to cause the wireless AP to:
transmit the first frame using the spatial reuse communication mode in accordance with a satisfaction of the threshold value, the satisfaction of the threshold value associated with at least the first signal strength measurement; and
update the threshold value by the delta value to obtain the second threshold value in association with transmitting the first frame using the spatial reuse communication mode and the failure to satisfy the criteria associated with the reception of the second frame.

11. The wireless AP of claim 10, wherein, to update the threshold value by the delta value to obtain the second threshold value, the processing system is configured to cause the wireless AP to:
increase the threshold value by the delta value in accordance with the satisfaction of the threshold value being associated with a difference between the first signal strength measurement and a second signal strength measurement at the wireless AP being greater than or equal to the threshold value; or
decrease the threshold value by the delta value in accordance with the satisfaction of the threshold value being associated with the first signal strength measurement being less than or equal to the threshold value.

12. The wireless AP of claim 9, wherein the processing system is further configured to cause the wireless AP to:
transmit the first frame using the multi-primary channel communication mode in accordance with a failure to satisfy the threshold value, the failure to satisfy the threshold value associated with at least the first signal strength measurement; and
update the threshold value by the delta value to obtain the second threshold value in association with transmitting the first frame using the multi-primary channel communication mode and the failure to satisfy the criteria associated with the reception of the second frame.

13. The wireless AP of claim 12, wherein, to update the threshold value by the delta value to obtain the second threshold value, the processing system is configured to cause the wireless AP to:
decrease the threshold value by the delta value in accordance with the failure to satisfy the threshold value being associated with a difference between the first signal strength measurement and a second signal strength measurement at the wireless AP being less than the threshold value; or
increase the threshold value by the delta value in accordance with the failure to satisfy the threshold value being associated with the first signal strength measurement being greater than the threshold value.

14. The wireless AP of claim 1, wherein the processing system is further configured to cause the wireless AP to:
maintain a respective threshold value for each wireless communication device associated with the wireless AP on a per-overlapping basic service set (OBSS) basis.

15. The wireless AP of claim 14, wherein the processing system is further configured to cause the wireless AP to:
transmit, to a first wireless communication device, using the spatial reuse communication mode or the multi-primary channel communication mode in accordance with at least the first signal strength measurement and with the threshold value, wherein the threshold value is maintained for interference from a first OBSS associated with the first signal strength measurement and communication with the first wireless communication device; and
transmit, to a second wireless communication device, using the spatial reuse communication mode or the multi-primary channel communication mode in accordance with at least a second signal strength measurement and a second threshold value, wherein the second threshold value is maintained for interference from a second OBSS associated with the second signal strength measurement and communication with the second wireless communication device.

16. The wireless AP of claim 1, wherein the processing system is further configured to cause the wireless AP to:
receive, from a wireless communication device associated with the wireless AP, information indicative of a capability of the wireless communication device to support the selection between the spatial reuse communication mode or the multi-primary channel communication mode, wherein the indication of the threshold value is transmitted to the wireless communication device in association with receiving the information indicative of the capability of the wireless communication device.

17. The wireless AP of claim 1, wherein the first signal strength measurement is an overlapping basic service set (OBSS) received signal strength indicator (RSSI).

18. A wireless station (STA), comprising:
a processing system that includes processor circuitry and memory circuitry that stores code, the processing system configured to cause the wireless STA to:
receive an indication of a threshold value associated with a selection between a spatial reuse communication mode or a multi-primary channel communication mode; and
communicate using the spatial reuse communication mode or the multi-primary channel communication mode in accordance with at least a first signal strength measurement at the wireless STA and with the threshold value.

19. The wireless STA of claim 18, wherein, to communicate using the spatial reuse communication mode or the multi-primary channel communication mode, the processing system is configured to cause the wireless STA to:
communicate using the spatial reuse communication mode in accordance with a satisfaction of the threshold value, the satisfaction of the threshold value associated with at least the first signal strength measurement; or
communicate using the multi-primary channel communication mode in accordance with a failure to satisfy the threshold value, the failure to satisfy the threshold value associated with at least the first signal strength measurement.

20. The wireless STA of claim 18, wherein the processing system is further configured to cause the wireless STA to:
receive an indication of an updated threshold value associated with the selection between the spatial reuse communication mode or the multi-primary channel communication mode; and
communicate using the spatial reuse communication mode or the multi-primary channel communication mode in accordance with the updated threshold value.

21. The wireless STA of claim 18, wherein the processing system is further configured to cause the wireless STA to:
transmit, using the spatial reuse communication mode or the multi-primary channel communication mode in accordance with at least the first signal strength measurement and with the threshold value, a first frame including a receiver address indicative of a wireless communication device;
update the threshold value by a delta value to a second threshold value in accordance with a failure to satisfy a criteria associated with reception, from the wireless communication device, of a second frame associated with the first frame; and
communicate with the wireless communication device using the spatial reuse communication mode or the multi-primary channel communication mode in accordance with the second threshold value.

22. The wireless STA of claim 18, wherein the processing system is further configured to cause the wireless STA to:
receive the indication of the threshold value via a broadcast management frame.

23. The wireless STA of claim 18, wherein the processing system is further configured to cause the wireless STA to:
receive the indication of the threshold value via an association response frame or a reassociation response frame.

24. The wireless STA of claim 18, wherein the processing system is further configured to cause the wireless STA to:
receive the indication of the threshold value via an aggregated control (A-Control) field of a management or data frame or via an action frame.

25. A method for wireless communication by a wireless access point (AP), comprising:
transmitting an indication of a threshold value associated with a selection between a spatial reuse communication mode or a multi-primary channel communication mode; and
communicating using the spatial reuse communication mode or the multi-primary channel communication mode in accordance with at least a first signal strength measurement at the wireless AP and with the threshold value.

26. The method of claim 25, wherein communicating using the spatial reuse communication mode or the multi-primary channel communication mode comprises:
communicating using the spatial reuse communication mode in accordance with a satisfaction of the threshold value, the satisfaction of the threshold value associated with at least the first signal strength measurement; or
communicating using the multi-primary channel communication mode in accordance with a failure to satisfy the threshold value, the failure to satisfy the threshold value associated with at least the first signal strength measurement.

27. The method of claim 26, wherein:
the satisfaction of the threshold value is in accordance with a difference between the first signal strength measurement and a second signal strength measurement at the wireless AP being greater than or equal to the threshold value; and
the failure to satisfy the threshold value is in accordance with the difference between the first signal strength measurement and the second signal strength measurement being less than the threshold value.

28. The method of claim 26, wherein:
the satisfaction of the threshold value is in accordance with the first signal strength measurement being less than or equal to the threshold value; and
the failure to satisfy the threshold value is in accordance with the first signal strength measurement being greater than the threshold value.

29. A method for wireless communication at a wireless station (STA), comprising:
receiving an indication of a threshold value associated with a selection between a spatial reuse communication mode or a multi-primary channel communication mode; and
communicating using the spatial reuse communication mode or the multi-primary channel communication mode in accordance with at least a first signal strength measurement at the wireless STA and with the threshold value.

30. The method of claim 29, wherein:
the threshold value is equal to a signal-to-interference plus noise ratio (SINR) at which a first data rate associated with the spatial reuse communication mode is greater than a second data rate associated with the multi-primary channel communication mode; or
the threshold value is equal to an interference level at which the spatial reuse communication mode is to be used instead of the multi-primary channel communication mode.
